(19) United States
(12) Patent Application Publication
(10) Pub. No.: US 2026/0057313 A1
(43) Pub. Date: Feb. 26, 2026

(54) SYSTEM AND METHOD FOR GENERATING AN ACTION STRATEGY

(71) Applicant: PLAIP, LLC, Tempe, AZ (US)

(72) Inventors: Tom Wheelwright, Tempe, AZ (US); Ryan Husk, Tempe, AZ (US)

(73) Assignee: PLAIP, LLC, Tempe, AZ (US)

(21) Appl. No.: 19/374,303

(22) Filed: Oct. 30, 2025

Related U.S. Application Data
(63) Continuation-in-part of application No. 18/110,469, filed on Feb. 16, 2023, now Pat. No. 12,468,997.

(51) Int. Cl. G06Q 10/0631

(52) U.S. Cl. CPC G06Q 10/0631

(57) ABSTRACT

A system for generating an action strategy is disclosed. The system includes at least a processor. The system includes a memory communicatively connected to the processor, the memory containing instructions configuring the at least a processor to receive composition data from a user, classify the composition data to one or more composition groups, provide a composition course as a function of the one or more composition groups, determine an action item as a function of the one or more composition groups, and generate an action strategy as a function of the action item.

### CROSS-REFERENCE TO RELATED APPLICATIONS

This application is a continuation-in-part of Non-provisional application Ser. No. 18/110,469 filed on Feb. 16, 2023, now U.S. Pat. No. 12,468,997, issued on Nov. 11, 2025, and entitled “SYSTEM AND METHOD FOR GENERATING AN ACTION STRATEGY,” the entirety of which is incorporated herein by reference.

### FIELD OF THE INVENTION

The present invention generally relates to the field of strategy generation. In particular, the present invention is directed to a system and method for generating an action strategy.

### BACKGROUND

Formulating a strategy helps understand strengths and weaknesses. With a strategy, one can analyze what one is good at and improve on one's weaker aspects. A strategy ensures that every aspect of one's life is planned. This means more efficiency and more effective plans. Existing solutions to generating strategy efficiently is not sufficient.

### SUMMARY OF THE DISCLOSURE

In an aspect, a system for generating an action strategy is disclosed. The system includes at least a processor. The system includes a memory communicatively connected to the processor, the memory containing instructions configuring the at least a processor to receive composition data from a user, classify the composition data to one or more composition groups, determine an action item as a function of the one or more composition groups, and generate an action strategy as a function of the action item.

In another aspect, a method for generating an action strategy. The method includes receiving, using at least a processor, composition data from a user. The method includes classifying, using at least a processor, the composition data to one or more composition groups. The method includes determining, using at least a processor, an action item as a function of the one or more composition groups. And the method includes generating, using at least a processor, an action strategy as a function of the action item.

These and other aspects and features of non-limiting embodiments of the present invention will become apparent to those skilled in the art upon review of the following description of specific non-limiting embodiments of the invention in conjunction with the accompanying drawings.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a block diagram illustrating an exemplary embodiment of a system for generating an action strategy;

FIG. 2 is a block diagram illustrating an exemplary embodiment of a machine-learning module;

FIG. 3 is a schematic diagram illustrating an exemplary embodiment of neural network;

FIG. 4 is a schematic diagram illustrating an exemplary embodiment of a node of a neural network;

FIG. 5 is a schematic diagram illustrating an exemplary embodiment of a deep neural network;

FIG. 6 is a block diagram illustrating an exemplary embodiment of a user interface system;

FIG. 7 is a flow diagram of an exemplary method for generating an action strategy; and

FIG. 8 is a block diagram of a computing system that can be used to implement any one or more of the methodologies disclosed herein and any one or more portions thereof.

The drawings are not necessarily to scale and may be illustrated by phantom lines, diagrammatic representations and fragmentary views. In certain instances, details that are not necessary for an understanding of the embodiments or that render other details difficult to perceive may have been omitted.

### DETAILED DESCRIPTION

At a high level, aspects of the present disclosure are directed to a system for generating an action strategy. The system includes at least a processor. The system includes a memory communicatively connected to the processor, the memory containing instructions configuring the at least a processor to receive composition data from a user, classify the composition data to one or more composition groups, provide a composition course as a function of the one or more composition groups, determine an action item as a function of the one or more composition groups, and generate an action strategy as a function of the action item. Exemplary embodiments illustrating aspects of the present disclosure are described below in the context of several specific examples.

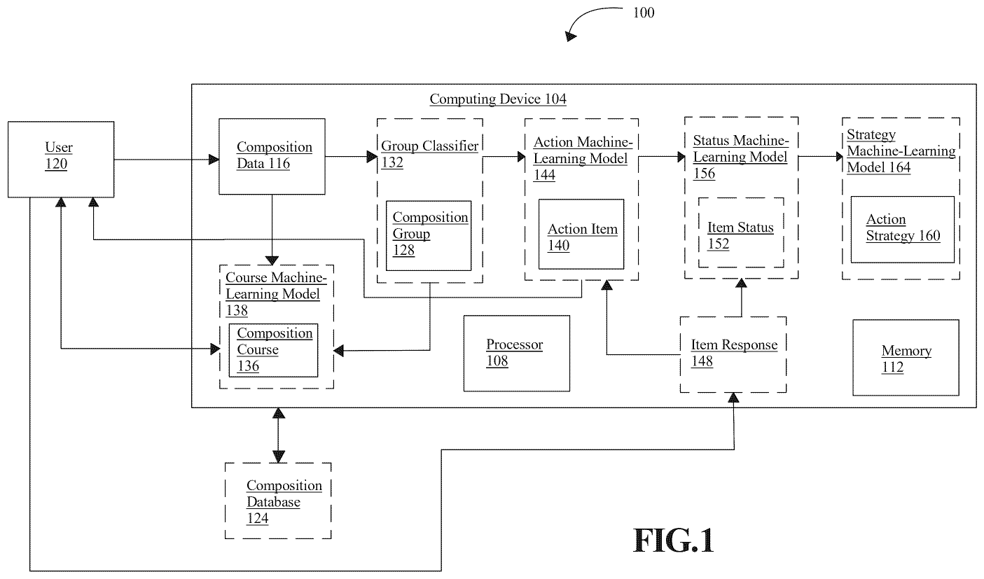

Referring now to FIG. 1, an exemplary embodiment of system 100 is illustrated. System 100 includes computing device 104. Computing device may include circuitry such as without limitation a processor communicatively connected to a memory; for instance, circuitry may include and/or be included in a computing device. Computing device 104 may include any computing device as described in this disclosure, including without limitation a microcontroller, microprocessor, digital signal processor (DSP) and/or system on a chip (SoC) as described in this disclosure. Computing device may include, be included in, and/or communicate with a mobile device such as a mobile telephone or smartphone. Computing device 104 may include a single computing device operating independently, or may include two or more computing device operating in concert, in parallel, sequentially or the like; two or more computing devices may be included together in a single computing device or in two or more computing devices. Computing device 104 may interface or communicate with one or more additional devices as described below in further detail via a network interface device. Network interface device may be utilized for connecting computing device 104 to one or more of a variety of networks, and one or more devices. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus, or other relatively small geographic space), a telephone network, a data network associated with a telephone/voice provider (e.g., a mobile communications provider data and/or voice network), a direct connection between two computing devices, and any combinations thereof. A network may employ a wired and/or a wireless mode of communication. In general, any network topology may be used. Information (e.g., data, software etc.) may be communicated to and/or from a computer and/or a computing device. Computing device 104 may include but is not limited to, for example, a computing device or cluster of computing devices in a first location and a second computing device or cluster of computing devices in a second location. Computing device 104 may include one or more computing devices dedicated to data storage, security, distribution of traffic for load balancing, and the like. Computing device 104 may distribute one or more computing tasks as described below across a plurality of computing devices of computing device, which may operate in parallel, in series, redundantly, or in any other manner used for distribution of tasks or memory between computing devices. Computing device 104 may be implemented using a “shared nothing” architecture in which data is cached at the worker, in an embodiment, this may enable scalability of system 100 and/or computing device.

Still referring to FIG. 1, circuitry may alternatively or additionally be implemented by configuring a hardware device such as a combinatorial or sequential logic circuit, an application-specific integrated circuit (ASIC), a field-programmable gate array (FPGA), or other hardware unit; memory may be attached thereto to further configure the hardware unit using read-only memory (ROM) or any other static or writable memory as described in this disclosure. Alternatively or additionally, hardware units and/or modules may be combined with and/or in communication with a processor, such as without limitation in a system-on-chip architecture wherein some functions are configured by modification or design of hardware circuitry, such as without limitation FPGA circuitry, while others are configured in the form of instructions in memory for one or more processors. As a non-limiting example, any step or combination of steps described herein may be performed entirely using hardware circuit configured to perform such steps either with static memory or rewritable memory. Such steps or combinations of steps may include signing with a digital signature, cryptographically hashing, evaluation of zero-knowledge proofs, or any other specific process described in this disclosure.

With continued reference to FIG. 1, computing device 104 may be designed and/or configured to perform any method, method step, or sequence of method steps in any embodiment described in this disclosure, in any order and with any degree of repetition. For instance, computing device 104 may be configured to perform a single step or sequence repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. Computing device 104 may perform any step or sequence of steps as described in this disclosure in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

With continued reference to FIG. 1, computing device 104 includes at least a processor 108 and a memory 112 communicatively connected to processor 108. As used in this disclosure, “communicatively connected” means connected by way of a connection, attachment, or linkage between two or more relata which allows for reception and/or transmittance of information therebetween. For example, and without limitation, this connection may be wired or wireless, direct, or indirect, and between two or more components, circuits, devices, systems, and the like, which allows for reception and/or transmittance of data and/or signal(s) therebetween. Data and/or signals therebetween may include, without limitation, electrical, electromagnetic, magnetic, video, audio, radio, and microwave data and/or signals, combinations thereof, and the like, among others. A communicative connection may be achieved, for example and without limitation, through wired or wireless electronic, digital, or analog, communication, either directly or by way of one or more intervening devices or components. Further, communicative connection may include electrically coupling or connecting at least an output of one device, component, or circuit to at least an input of another device, component, or circuit. For example, and without limitation, via a bus or other facility for intercommunication between elements of computing device 104. Communicative connecting may also include indirect connections via, for example and without limitation, wireless connection, radio communication, low power wide area network, optical communication, magnetic, capacitive, or optical coupling, and the like. In some instances, the terminology “communicatively coupled” may be used in place of communicatively connected in this disclosure. Computing device 104 may include, be included in, and/or communicate with a remote device. As used in this disclosure, a “remote device” is any device suitable for use as a computing device. As a non-limiting example, a remote device may include an end-user device such as a desktop computer, work terminal, laptop computer, netbook, mobile device. As a non-limiting example, a mobile device may include a smartphone or tablet, or the like.

With continued reference to FIG. 1, computing device 104 may be configured to provide a visual interface. A “visual interface,” as used in this disclosure, is graphical user interface (GUI) that displays graphical models, as defined below, to a user of a remote device and permits user to manipulate, move, edit, connect together, and/or otherwise interact with such graphical models and/or combinations thereof. Visual interface may include a window in which graphical models, and/or combinations thereof, to be used may be displayed. Visual interface may include one or more graphical locator and/or cursor facilities allowing a user to interact with graphical models and/or combinations thereof, for instance using a touchscreen, touchpad, mouse, keyboard, and/or other manual data entry device. Visual interface may include one or more menus and/or panels permitting selection of tools, options, graphical models to be displayed and/or used, elements of data, functions, or other aspects of graphical models to be edited, added, and/or manipulated, options for importation of and/or linking to application programmer interfaces (APIs), exterior services, databases, machine-learning models, and/or algorithms, or the like. Persons skilled in the art, upon reviewing the entirety of this disclosure, will be aware of various ways in which a visual interface and/or elements thereof may be implemented and/or used as described in this disclosure.

With continued reference to FIG. 1, memory 112 contains instructions configuring processor 108 to receive composition data 116 from a user 120. As used in this disclosure, a “user” is a person who uses an apparatus. As a non-limiting example, user 120 may include an individual, a family, a business, and/or other groups of persons. As used in this disclosure, “composition data” is any data that is related to a user. In an embodiment, composition data 116 may include user personal information. As a non-limiting example, user personal information may include a name, gender, social security number, personal schedules, hobbies, dependents, family, profession, and the like. In another embodiment, composition data 116 may include user financial information. As a non-limiting example, user financial information may include cash reserves, assets, stocks, bonds, mutual funds, exchange-traded funds (ETF), equity, debts, real estates, incomes, pecuniary goals, business plan, retirement accounts, liabilities, and the like. A pecuniary goal disclosed herein is described further in detail below. In some embodiments, composition data 116 may be stored in strategy database 124. In some embodiments, composition data 116 may be retrieved from strategy database 124. Strategy database 124 disclosed herein is described further in detail below. In some embodiments, at least a processor 108 may interface with application programming interface to obtain composition data 116. As used herein, an “application programming interface,” also known as “API” is a set of functions that allow applications to access data and interact with external software components, operating systems, or microdevices, such as a computing device.

With continued reference to FIG. 1, in some embodiments, composition data 116 may include document data. As used in this disclosure, “document data” is any data obtained from documentation submitted by a user. As used in this disclosure, a “documentation” is a material that serves as a record and provides official information. As a non-limiting example, document data may include W-2, paystubs, bank statements, profit and loss (P&L) statements, balance sheet, cash flow statements, income statements, aging reports, budget report, business plan, and the like. In some embodiments, composition data 116 may be filled with document data accordingly once documentation gets submitted by a user. As a non-limiting example, composition data 116 may include a name of a user obtained from document data when document data includes the name of the user from W-2. As another example, composition data 116 may include current cash reserves of a user when document data include the amount of cash reserves of the user from cash flow statements. In some embodiments, a user may input composition data 116 manually. As a non-limiting example, a user may input manually the amount of debts the user has into computer device 104 using a keyboard.

With continued reference to FIG. 1, in some embodiments, at least a processor 108 may obtain document data using optical character recognition. Optical character recognition (OCR) may include automatic conversion of images of written, such as without limitation typed, handwritten or printed text, into machine-encoded text. In some cases, recognition of at least a keyword from an image component may include one or more processes, including without limitation optical character recognition (OCR), optical word recognition, intelligent character recognition, intelligent word recognition, and the like. In some cases, OCR may recognize written text, one glyph or character at a time. In some cases, optical word recognition may recognize written text, one word at a time, for example, for languages that use a space as a word divider. In some cases, intelligent character recognition (ICR) may recognize written text one glyph or character at a time, for instance by employing machine learning processes. In some cases, intelligent word recognition (IWR) may recognize written text, one word at a time, for instance by employing machine learning processes.

With continued reference to FIG. 1, in some cases, OCR may be an “offline” process, which analyses a static document or image frame. In some cases, handwriting movement analysis can be used as input to a handwriting recognition. For example, instead of merely using shapes of glyphs and words, this technique may capture motions, such as the order in which segments are drawn, the direction, and the pattern of putting the pen down and lifting it. This additional information can make handwriting recognition more accurate. In some cases, this technology may be referred to as “online” character recognition, dynamic character recognition, real-time character recognition, and intelligent character recognition.

With continued reference to FIG. 1, in some cases, OCR processes may employ pre-processing of image component. Pre-processing process may include without limitation de-skew, de-speckle, binarization, line removal, layout analysis or “zoning,” line and word detection, script recognition, character isolation or “segmentation,” and normalization. In some cases, a de-skew process may include applying a transform, such as without limitation homography or affine transform, to image component to align text. In some cases, a de-speckle process may include removing positive and negative spots and/or smoothing edges. In some cases, a binarization process may include converting an image from color or greyscale to black-and-white, such as without limitation a binary image. Binarization may be performed as a simple way of separating text or any other desired image component from a background of image component. In some cases, binarization may be required for example if an employed OCR algorithm only works on binary images. In some cases. A line removal process may include removal of non-glyph or non-character imagery, such as without limitation boxes and lines. In some cases, a layout analysis or “zoning” process may identify columns, paragraphs, captions, and the like as distinct blocks. In some cases, a line and word detection process may establish a baseline for word and character shapes and separate words, if necessary. In some cases, a script recognition process may, for example in multilingual documents, identify script allowing an appropriate OCR algorithm to be selected. In some cases, a character isolation or “segmentation” process may separate signal characters, for example character-based OCR algorithms. In some cases, a normalization process may normalize aspect ratio and/or scale of image component.

With continued reference to FIG. 1, in some embodiments an OCR process will include an OCR algorithm. Exemplary OCR algorithms include matrix matching process and/or feature extraction processes. Matrix matching may involve comparing an image to a stored glyph on a pixel-by-pixel basis. In some case, matrix matching may also be known as “pattern matching,” “pattern recognition,” and/or “image correlation.” Matrix matching may rely on an input glyph being correctly isolated from the rest of the image component. Matrix matching may also rely on a stored glyph being in a similar font and at a same scale as input glyph. Matrix matching may work best with typewritten text.

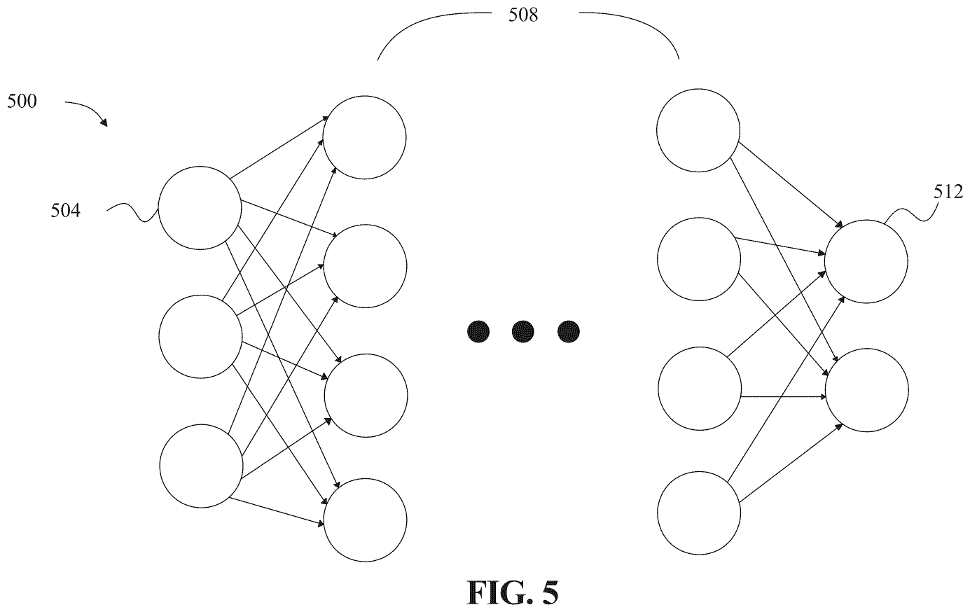

With continued reference to FIG. 1, in some embodiments, an OCR process may include a feature extraction process. In some cases, feature extraction may decompose a glyph into features. Exemplary non-limiting features may include corners, edges, lines, closed loops, line direction, line intersections, and the like. In some cases, feature extraction may reduce dimensionality of representation and may make the recognition process computationally more efficient. In some cases, extracted feature can be compared with an abstract vector-like representation of a character, which might reduce to one or more glyph prototypes. General techniques of feature detection in computer vision are applicable to this type of OCR. In some embodiments, machine-learning process like nearest neighbor classifiers (e.g., k-nearest neighbors algorithm) can be used to compare image features with stored glyph features and choose a nearest match. OCR may employ any machine-learning process described in this disclosure, for example machine-learning processes described with reference to FIGS. 5-8. Exemplary non-limiting OCR software includes Cuneiform and Tesseract. Cuneiform is a multi-language, open-source optical character recognition system originally developed by Cognitive Technologies of Moscow, Russia. Tesseract is free OCR software originally developed by Hewlett-Packard of Palo Alto, California, United States.

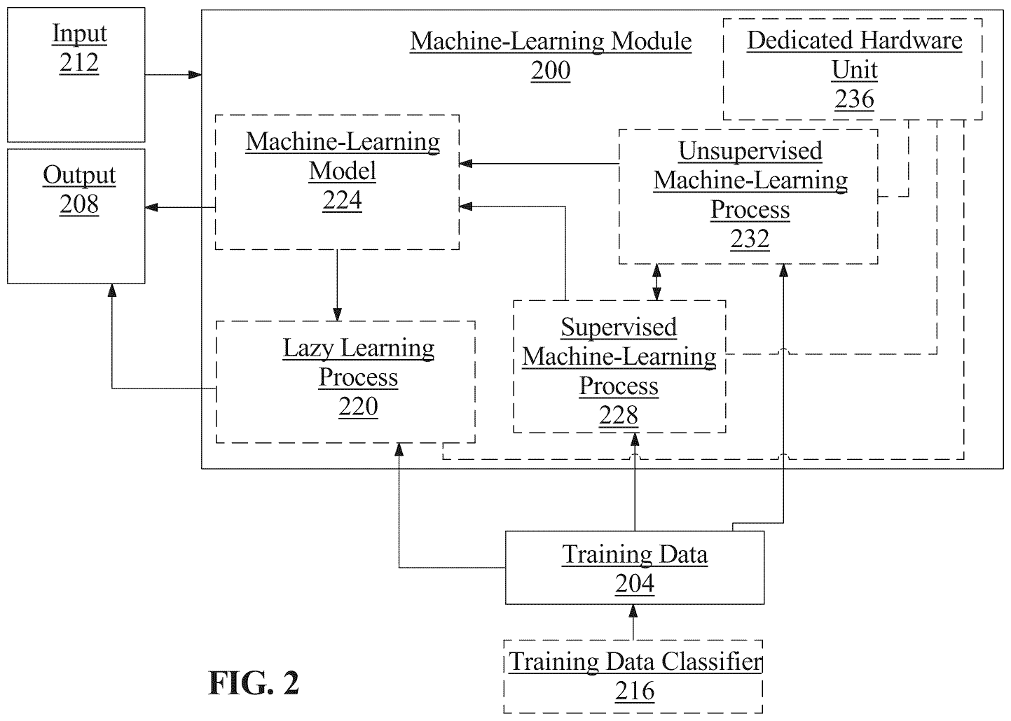

With continued reference to FIG. 1, in some cases, OCR may employ a two-pass approach to character recognition. Second pass may include adaptive recognition and use letter shapes recognized with high confidence on a first pass to recognize better remaining letters on the second pass. In some cases, two-pass approach may be advantageous for unusual fonts or low-quality image components where visual verbal content may be distorted. Another exemplary OCR software tool may include OCRopus. OCRopus development is led by German Research Centre for Artificial Intelligence in Kaiserslautern, Germany. In some cases, OCR software may employ neural networks, for example neural networks as described in reference to FIGS. 2-4.

With continued reference to FIG. 1, in some cases, OCR may include post-processing. For example, OCR accuracy can be increased, in some cases, if output is constrained by a lexicon. A lexicon may include a list or set of words that are allowed to occur in a document. In some cases, a lexicon may include, for instance, all the words in the English language, or a more technical lexicon for a specific field. In some cases, an output stream may be a plain text stream or file of characters. In some cases, an OCR process may preserve an original layout of visual verbal content. In some cases, near-neighbor analysis can make use of co-occurrence frequencies to correct errors, by noting that certain words are often seen together. For example, “Washington, D.C.” is generally far more common in English than “Washington DOC.” In some cases, an OCR process may make us of a priori knowledge of grammar for a language being recognized. For example, grammar rules may be used to help determine if a word is likely to be a verb or a noun. Distance conceptualization may be employed for recognition and classification. For example, a Levenshtein distance algorithm may be used in OCR post-processing to further optimize results.

With continued reference to FIG. 1, in some embodiments, at least a processor 108 may obtain document data using a language processing module. Language processing module may include any hardware and/or software module. Language processing module may be configured to extract, from the one or more documents, one or more words. One or more words may include, without limitation, strings of one or more characters, including without limitation any sequence or sequences of letters, numbers, punctuation, diacritic marks, engineering symbols, geometric dimensioning and tolerancing (GD&T) symbols, chemical symbols and formulas, spaces, whitespace, and other symbols, including any symbols usable as textual data as described above. Textual data may be parsed into tokens, which may include a simple word (sequence of letters separated by whitespace) or more generally a sequence of characters as described previously. The term “token,” as used herein, refers to any smaller, individual groupings of text from a larger source of text; tokens may be broken up by word, pair of words, sentence, or other delimitation. These tokens may in turn be parsed in various ways. Textual data may be parsed into words or sequences of words, which may be considered words as well. Textual data may be parsed into “n-grams”, where all sequences of n consecutive characters are considered. Any or all possible sequences of tokens or words may be stored as “chains”, for example for use as a Markov chain or Hidden Markov Model.

With continued reference to FIG. 1, language processing module may operate to produce a language processing model. Language processing model may include a program automatically generated by computing device and/or language processing module to produce associations between one or more words extracted from at least a document and detect associations, including without limitation mathematical associations, between such words. Associations between language elements, where language elements include for purposes herein extracted words, relationships of such categories to other such term may include, without limitation, mathematical associations, including without limitation statistical correlations between any language element and any other language element and/or language elements. Statistical correlations and/or mathematical associations may include probabilistic formulas or relationships indicating, for instance, a likelihood that a given extracted word indicates a given category of semantic meaning. As a further example, statistical correlations and/or mathematical associations may include probabilistic formulas or relationships indicating a positive and/or negative association between at least an extracted word and/or a given semantic meaning; positive or negative indication may include an indication that a given document is or is not indicating a category semantic meaning. Whether a phrase, sentence, word, or other textual element in a document or corpus of documents constitutes a positive or negative indicator may be determined, in an embodiment, by mathematical associations between detected words, comparisons to phrases and/or words indicating positive and/or negative indicators that are stored in memory at computing device, or the like.

With continued reference to FIG. 1, language processing module and/or diagnostic engine may generate the language processing model by any suitable method, including without limitation a natural language processing classification algorithm; language processing model may include a natural language process classification model that enumerates and/or derives statistical relationships between input terms and output terms. Algorithm to generate language processing model may include a stochastic gradient descent algorithm, which may include a method that iteratively optimizes an objective function, such as an objective function representing a statistical estimation of relationships between terms, including relationships between input terms and output terms, in the form of a sum of relationships to be estimated. In an alternative or additional approach, sequential tokens may be modeled as chains, serving as the observations in a Hidden Markov Model (HMM). HMMs as used herein are statistical models with inference algorithms that that may be applied to the models. In such models, a hidden state to be estimated may include an association between extracted words, phrases, and/or other semantic units. There may be a finite number of categories to which an extracted word may pertain; an HMM inference algorithm, such as the forward-backward algorithm or the Viterbi algorithm, may be used to estimate the most likely discrete state given a word or sequence of words. Language processing module may combine two or more approaches. For instance, and without limitation, machine-learning program may use a combination of Naive-Bayes (NB), Stochastic Gradient Descent (SGD), and parameter grid-searching classification techniques; the result may include a classification algorithm that returns ranked associations.

With continued reference to FIG. 1, generating language processing model may include generating a vector space, which may be a collection of vectors, defined as a set of mathematical objects that can be added together under an operation of addition following properties of associativity, commutativity, existence of an identity element, and existence of an inverse element for each vector, and can be multiplied by scalar values under an operation of scalar multiplication compatible with field multiplication, and that has an identity element is distributive with respect to vector addition, and is distributive with respect to field addition. Each vector in an n-dimensional vector space may be represented by an n-tuple of numerical values. Each unique extracted word and/or language element as described above may be represented by a vector of the vector space. In an embodiment, each unique extracted and/or other language element may be represented by a dimension of vector space; as a non-limiting example, each element of a vector may include a number representing an enumeration of co-occurrences of the word and/or language element represented by the vector with another word and/or language element. Vectors may be normalized, scaled according to relative frequencies of appearance and/or file sizes. In an embodiment associating language elements to one another as described above may include computing a degree of vector similarity between a vector representing each language element and a vector representing another language element; vector similarity may be measured according to any norm for proximity and/or similarity of two vectors, including without limitation cosine similarity, which measures the similarity of two vectors by evaluating the cosine of the angle between the vectors, which can be computed using a dot product of the two vectors divided by the lengths of the two vectors. Degree of similarity may include any other geometric measure of distance between vectors.

With continued reference to FIG. 1, language processing module may use a corpus of documents to generate associations between language elements in a language processing module, and diagnostic engine may then use such associations to analyze words extracted from one or more documents and determine that the one or more documents indicate significance of a category. In an embodiment, language module and/or computing device 104 may perform this analysis using a selected set of significant documents, such as documents identified by one or more experts as representing good information; experts may identify or enter such documents via graphical user interface, or may communicate identities of significant documents according to any other suitable method of electronic communication, or by providing such identity to other persons who may enter such identifications into computing device 104. Documents may be entered into a computing device by being uploaded by an expert or other persons using, without limitation, file transfer protocol (FTP) or other suitable methods for transmission and/or upload of documents; alternatively or additionally, where a document is identified by a citation, a uniform resource identifier (URI), uniform resource locator (URL) or other datum permitting unambiguous identification of the document, diagnostic engine may automatically obtain the document using such an identifier, for instance by submitting a request to a database or compendium of documents such as JSTOR as provided by Ithaka Harbors, Inc. of New York. Language model may alternatively or additionally be, be included in, and/or include a generative model and/or a plurality of models implementing generative AI, a large language model, or the like as described in further detail below.

With continued reference to FIG. 1, in some embodiments, composition data 116 may include survey data. As used in this disclosure, “survey data” is data obtained from a survey. As used in this disclosure, a “survey” is a data collection tool in which a list of questions is used to gather information about a user. As a non-limiting example, a user may select, type, and the like into a survey. In an embodiment, a survey may allow a user to answer a multiple-choice question. In some embodiments, a user may select one or more answers. In some embodiments, a multiple-choice question may include two choices, three choices, four choices, five choices, six choices, and the like. As a non-limiting example, a user may select a single answer between ‘single,’ ‘married,’ ‘divorced,’ ‘widowed,’ ‘separated,’ ‘living with partner’ for a question of ‘what is your marital status?’ As a non-limiting example, a user may select multiple answers between ‘I didn't have time for investment,’ ‘I had no any interests in investment,’ ‘I didn't like the idea of investment,’ ‘I didn't want to take a risk,’ ‘I tried doing on my own and failed,’ ‘I wanted to but I know nothing about investment’ for a question of ‘what is the reason you have not been investing In another embodiment, a survey may allow a user to answer an ordinal scale question. As used in this disclosure, an “ordinal scale question” is a question that allows to rank a range of items or to choose from an ordered set. The ordinal scale question may be helpful to find the importance level of a matter. As a non-limiting example, a user may rank the importance, using number 1 through 5 with 1 being the most important, between ‘high risk, high return,’ ‘low risk, low return,’ ‘short term investment, ‘long term investment’ for a question of ‘which investment approach do you prefer?’ In another embodiment, a survey may allow a user to answer an interval scale question. As a non-limiting example, a user may select between ‘very poor,’ ‘poor,’ ‘neutral,’ ‘good,’ ‘excellent’ for a question of ‘Please rate your risk tolerance level.’ In some embodiments, a survey may allow a user to answer an open-ended question. As a non-limiting example, a user may type an answer to a question ‘Do you have anything you would like to share with us?’ As another non-limiting example, a user may type an answer to a question ‘What is your financial goal?’ Additionally, without limitation, a financial goal disclosed herein may be consistent with a pecuniary goal disclosed in this disclosure.

With continued reference to FIG. 1, processor 108 is configured to classify composition data 116 to one or more composition groups 128. As used in this disclosure, a “composition group” is a set of associative composition data. As a non-limiting example, one or more composition groups 128 may include a tax group, a revenue group, a saving group, an investing group, a retirement group, an inheritance group, and the like. As used in this disclosure, a “tax group” is a group of composition data that is related to tax. As a non-limiting example, a tax group may include a pecuniary goal of a user that is related to a tax. As another non-limiting example, tax group may include composition data 116 related to tax, such as without limitation W-2s, paystubs, social security documents, income statements, previous tax returns, bank account number, and the like. As used in this disclosure, a “revenue group,” is a group of composition data that is related to revenue. As a non-limiting example, a revenue group may include a pecuniary goal related to a revenue. As another non-limiting example, a revenue group may include composition data 116 related to revenue, such as without limitation income statements, bank account number, cash flow statement, and the like. As used in this disclosure, a “saving group” is a group of composition data that is related to saving. As a non-limiting example, a saving group may include a pecuniary goal related to a saving. As another non-limiting example, a saving group may include composition data 116 related to saving, such as without limitation saving bank account number, bank statement, and the like. As used in this disclosure, an “investing goal group” is a group of composition data that is related to investing. As a non-limiting example, an investing group may include a pecuniary goal of a user that is related to investing. As another non-limiting example, investing group may include composition data 116 related to investing, such as without limitation balance sheets, investment income forms, bank statements, and the like.

With continued reference to FIG. 1, in some embodiments, each of one or more composition groups 128 may include a goal group. As used in this disclosure, a “goal group” is a group that includes a composition data that is related to a pecuniary goal. The pecuniary goal disclosed herein is further described below. As a non-limiting example, a goal group may include a tax goal group, investing goal group, revenue goal group, saving goal group, retirement goal group, inheritance goal group, and the like. In an embodiment, each of one or more composition groups 128 may include a plurality of pecuniary goals. As a non-limiting example, an investing group May include an investing goal group that includes a plurality of pecuniary goals, wherein the plurality of pecuniary goals may include ‘investing into three new entities in stock’ and ‘buying a house.’ In another embodiment, each of one or more composition groups 128 may not include a goal group. As a non-limiting example, a tax group may not include a tax goal group when a user 120 does not have a pecuniary goal related to tax. As another non-limiting example, each of one or more composition groups 128 may not include an inheritance goal group when a user 120 does not have a pecuniary goal related to inheritance. In some embodiments, each of one or more composition groups 128 may include a non-goal group. For the purposes of this disclosure, a “non-goal group” is composition data that is not related to a pecuniary goal of a user. As a non-limiting example, a non-goal group may include user personal information, such as without limitation a name, gender, family, dependent, and the like. As a non-limiting example, a non-goal group may include document data that is not related to a pecuniary goal such as without limitation W-2, bank statement, P&L statement, balance sheet, and the like. As another non-limiting example, non-goal group may include survey data that is not related to a pecuniary goal.

With continued reference to FIG. 1, as used in this disclosure, a “pecuniary goal” is a target to aim for when managing money of a user. In some embodiments, a pecuniary goal may include a goal for saving, spending, earning, investing, retirement, inheritance, and the like. As a non-limiting example, a pecuniary goal may include saving 100,000 dollars over ten months. As another non-limiting example, a pecuniary goal may include growing 200,000 dollars over a year. As another non-limiting example, a pecuniary goal may include reducing tax liability. As another non-limiting example, a pecuniary goal may include planning a retirement plan. As another non-limiting example, a pecuniary goal may include reducing debt. As another non-limiting example, a pecuniary goal may include improving the profit margin. As another non-limiting example, a pecuniary goal may include revenue growth. As another non-limiting example, a pecuniary goal may include managing cash flow. As another non-limiting example, a pecuniary goal may include passing wealth on to a user's children. As a non-limiting example, a pecuniary goal may include merging with another firm. As a non-limiting example, a pecuniary goal may include getting a new partner for a company. In an embodiment, a pecuniary goal may be manually input by a user 120. As a non-limiting example, at least a processor 108 may receive a pecuniary goal from document data. As another non-limiting example, at least a processor 108 may receive a pecuniary goal from survey data. As another non-limiting example, a user 120 may manually input a pecuniary goal to at least a processor 108. In another embodiment, pecuniary goal may be put by an advisor, wherein the advisor disclosed herein is described further in detail below.

With continued reference to FIG. 1, in some embodiments, composition data 116 may be classified to one or more composition groups 128 using a group classifier 132. As used in this disclosure, a “group classifier” is a machine-learning model, such as a mathematical model, neural net, or program generated by a machine learning algorithm known as a “classification algorithm,” that sorts composition data related inputs into categories or bins of data, outputting a plurality of composition groups associated therewith. The group classifier 132 disclosed herein may be consistent with a classifier disclosed with respect to FIG. 2. In some embodiments, a group classifier 132 may be trained with training data correlating composition data 116 to one or more composition group 128. As a non-limiting example, a group classifier 132 may be trained with group training data that correlates document data of W-2 to tax group and revenue group. As another non-limiting example, a group classifier 132 may be trained with group training data that correlates composition data 116 of bank account number to revenue group, saving group, heritance group and retirement group. As another non-limiting example, a group classifier 132 may be trained with group training data that correlates composition data 112 of previous tax returns to tax group. As another non-limiting example, a group classifier 132 may correlate composition data 116 of a pecuniary goal related to investing to investing group. In some embodiments, the training data may be received from a user 120, composition database 124, external computing devices, and/or previous iterations of processing. In some embodiments, group classifier 132 may classify composition data 116 into one or more composition groups 128 as a function of a pecuniary goal of a user.

With continued reference to FIG. 1, in some embodiments, composition data 116 may be classified to one or more composition groups 128 using a group lookup table. A “lookup table,” for the purposes of this disclosure, is an array of data that maps input values to output values. A lookup table may be used to replace a runtime computation with an array indexing operation. As a non-limiting example, a course lookup table may relate a user financial information of composition data 116 to one or more composition groups 128. As a non-limiting example, a computing device 104 may relate user personal information to a non-goal group of composition group 128. As another non-limiting example, a group lookup table may relate user financial information to a plurality of goal groups of composition course 136. As a non-limiting example, computing device 104 may be configured to “lookup” a given pecuniary goal of a user to find a corresponding a plurality of goal groups of composition courses 136. As a non-limiting example, computing device 104 may be configured to “lookup” a given pecuniary goal of a user to ‘reduce tax liability’ in order to find a corresponding one or more composition groups 128 such as without limitation a tax group. As another non-limiting example, computing device 104 may be configured to “lookup” a given composition data 116 of bank statements in order to find a corresponding one or more composition groups 128 such as without limitation, a saving group, an investing group, a retirement goal group, and the like.

With continued reference to FIG. 1, in some embodiments, one or more composition groups 128 may be reviewed by an advisor. As used in this disclosure, an “advisor” is a person who is a professional related to a matter. As a non-limiting example, an advisor may include a service team, an attorney, a financial advisor, a certified public accountant (CPA), an auditor, and the like. In some embodiments, each of a plurality of advisors may have different accessibility to one or more composition groups 128. As used in this disclosure, “accessibility” refers to the limited ability to get access to one or more composition groups, for instance and without limitation as established using digital and/or computer access rights. As a non-limiting example, a financial advisor may have accessibility to tax group and invest goal group, but not to non-goal group. As another non-limiting example, a CPA may have accessibility to tax group but not to invest goal group. As another non-limiting example, a service team may only have accessibility to a non-goal group. In some embodiments, a user may be able to communicate with an advisor. As a non-limiting example, a user may be able to communicate with an attorney using a live chat. As used in this disclosure, a “live chat” is a medium that allows a user to interact with an advisor in real-time. In an embodiment, a user may communicate with an advisor through a call. In another embodiment, a user may communicate with an advisor through a message. In another embodiment, a user may interact with an advisor through an email.

With continued reference to FIG. 1, in some embodiments, at least a processor 108 is configured to provide a composition course 136. As used in this disclosure, a “composition course” is an informative session that provides information to a user. In some embodiments, composition courses 136 may allow a user to develop one's financial knowledge. In an embodiment, composition course 136 may include a definition of terms for composition data 116. As a non-limiting example, composition course 136 may include information on ‘what is cash reserves’, ‘what is financial goal’, ‘what is liability’, ‘what is risk-tolerance,’ and the like. In another embodiment, composition course 136 may include information on how to put one or more composition data 116 to a computing device 104. As a non-limiting example, composition course 136 may include information on ‘how to fill a tax return’, ‘how to set financial goals’, and the like. In some embodiments, composition course 136 may include an assessment. For the purposes of this disclosure, an “assessment” is a type of test that evaluates a user's knowledge. In an embodiment, an assessment may include a question that tests a user 120's pecuniary knowledge. As a non-limiting example, pecuniary knowledge may include knowledge on tax, loan, debt, earning money, saving money, investing, setting a pecuniary goal, and the like. In some embodiments, an assessment may allow a user 120 to type, click, move, speak, and the like. In an embodiment, a user 120 may pass an assessment when the user 120 inputs a correct answer to a question of the assessment. In another embodiment, a user 120 may fail an assessment when the user 120 inputs a wrong answer to a question of the assessment. In some embodiments, a user 120 may retake an assessment when the user failed the assessment. In some embodiments, a user 120 may skip to retake an assessment if the user 120 wants to skip it. In some embodiments, composition course 136 may include one or more formats. In an embodiment, composition course 136 may include a format of text. As used in this disclosure, a format of “text” refers to a format of a written words. As a non-limiting example, composition course 136 may allow a user to read a definition of liability written in text format. In another embodiment, composition course 136 may include a video format. As a non-limiting example, composition course 136 may include a video lecture explaining a difference between value investing and quality investing. As another non-limiting example, composition course 136 may include a video lecture explaining how to fill a tax return. In another embodiment, composition course 136 may include audio format. In some embodiments, a user may interact with composition course 136. As a non-limiting example, a user may interact with composition course 136 by selecting, deleting, moving, typing, and the like.

With continued reference to FIG. 1, in some embodiments, composition course 136 may be provided to a user 120 before the user input composition data 116 into computing device 104. As a non-limiting example, at least a processor 108 may provide a lecture on ‘how to set a pecuniary goal’ to a user before the user put a pecuniary goal into computing device 104. As another non-limiting example, at least a processor 108 may provide a definition of a cash reserve to a user before the user put amount of cash reserve the user has into computing device 104. In some embodiments, composition course 136 may be determined as a function of one or more composition groups 128. In some embodiments, composition course 136 may be provided to a user after the user put composition data 116 into computing device. As a non-limiting example, at least a processor 108 may provide a video lecture of explaining a difference between value investing and quality investing to a user when the user put composition data 116, such as without limitation a pecuniary goal related to investing, into computing device 104.

With continued reference to FIG. 1, in some embodiments, composition course 136 may be provided to a user 120 after the user 120 input composition data 116 into computing device 104. As a non-limiting example, at least a processor 108 may provide an assessment to a user 120, wherein the assessment may include a question that tests the user 120's pecuniary knowledge. In some embodiments, composition course 136 may include an assessment that may include a question that tests if a user 120 remembers a content from a previous composition course 136. As a non-limiting example, if at least a processor 108 provided a composition course 136 of a definition of liability, another composition course 136 that includes an assessment that tests a user 120's knowledge on the definition of liability may be provided to the user 120. As another non-limiting example, if at least a processor 108 provided a composition course 136 of a lecture of explaining how to fill a tax return, another composition course 136 that includes an assessment that tests a user 120's knowledge on how to fill a tax return may be provided to the user 120. In an embodiment, a user 120 may decide to take a composition course 136. In another embodiment, a user 120 may decide to skip a composition course 136. In some embodiments, an advisor may add a composition course 136 for a user 120. In some embodiments, an advisor may remove a composition course 136 for a user 120.

With continued reference to FIG. 1, in some embodiments, composition course 136 may be determined using a course lookup table. As a non-limiting example, a course lookup table may relate one or more composition groups 128 to composition course 136. As a non-limiting example, a computing device 104 may relate a non-goal group to composition course 136. As another non-limiting example, a course lookup table may relate user financial information to composition course 136. As a non-limiting example, computing device 104 may be configured to “lookup” a given pecuniary goal of a user to find a corresponding composition course 136. As a non-limiting example, computing device 104 may be configured to “lookup” a given pecuniary goal of a user to ‘reduce tax liability’ in order to find a corresponding composition course 136, such as a text of a definition of liability, a video lecture of a number of methods that can be used to reduce tax liability, and the like.

With continued reference to FIG. 1, in some embodiments, at least a processor 108 may determine a composition course 136 using a course machine-learning model 138. As used in this disclosure, a “course machine-learning model” is a machine-learning model that is used to determine a composition course. In some embodiments, a course machine-learning model 138 may be trained with course training data correlating one or more composition groups 128 to composition course 136. As a non-limiting example, a course machine-learning model 138 may be trained with course training data correlating a tax group to composition course 136 of assessment related to a tax. As another limiting example, a course machine-learning model 138 may be trained with course training data correlating an investing group to a composition course 136 of a lecture related to an investing. In some embodiments, a course machine-learning model 138 may be trained with course training data correlating composition data 116 to composition course 136. As a non-limiting example, a course machine-learning model 138 may correlate a composition data 116 to a composition course 136 of a definition of the composition data 116. In some embodiments, a course machine-learning model 138 may be trained with course training data correlating a course composition course 136 to another course composition course 136. As a non-limiting example, a course learning-machine model 138 may correlate a composition course 136 of a lecture of explaining how to fill a tax return to another composition course 136 that includes an assessment that tests a user 120's knowledge on how to fill a tax return. In some embodiments, composition course 136 may be provided in sequence. In some embodiments, a second composition course 136 may be provided as a first composition course 136 is completed. As a non-limiting example, a user 120 may not be able to take a second composition course 136 unless the user 120 takes and/or passes a first composition course 136. In some embodiments, course training data may be received from a user 120, an advisor, composition database 124, external computing devices, previous iterations of processing, and/or the like.

With continued reference to FIG. 1, in some embodiments, at least a processor 108 may determine a composition course 136 using a course lookup table. As a non-limiting example, a course lookup table may relate one or more composition group 128 to composition course 136. In some embodiments, at least a processor 108 may ‘lookup’ a given one or more composition groups 128 to find a corresponding composition course 136 using a course lookup table. As a non-limiting example, at least a processor 108 may ‘lookup’ a tax group to find a corresponding composition course 136 related to tax. In some embodiments, at least a processor 108 may ‘lookup’ a given composition data 116 to find a corresponding composition course 136 using a course lookup table. As a non-limiting example, at least a processor 108 may ‘lookup’ a given composition data 116 of a user 120's pecuniary goal to a composition course 136 of ‘how to set a pecuniary goal.’ In some embodiments, at least a processor 108 may ‘lookup’ a given composition course 136 to find a corresponding composition course 136 using a course lookup table. As a non-limiting example, at least a processor 108 may correlate a composition course 136 of a lecture of explaining how to fill a tax return to another composition course 136 that includes an assessment that tests a user 120's knowledge on how to fill a tax return using a course lookup table.

With continued reference to FIG. 1, a processor 108 is configured to determine an action item 140. As used in this disclosure, an “action item” is any action that is needed to be taken to generate an action strategy. In some embodiments, action item 140 may include a course action, document action, advisor action, focus action, research action, and the like. As used in this disclosure, a ‘course action’ is an action related to a composition course. As a non-limiting example, a course action may include ‘take a course,’ ‘retake a course,’ and the like. The course disclosed herein may be a composition course 136. As used in this disclosure, a ‘document action’ is an action related to documentation. As a non-limiting example, a document action may include ‘submit documentation,’ ‘review documentation,’ and the like. As used in this disclosure, an ‘advisor action’ is an action related to a review. As a non-limiting example, a review action may include ‘a meeting with an advisor,’ ‘chatting with an advisor,’ and the like. As a non-limiting example, a meeting with an advisor may include live chatting, speaking on a call, sending an email, a meeting in person, and the like. As used in this disclosure, a “focus action” is an action related to determining a focus of an action strategy. As used in this disclosure, a “focus” of an action strategy is a main point of attention of an action strategy. As a non-limiting example, a focus action may include ‘determine a focus,’ ‘review a focus,’ ‘change a focus,’ and the like. As used in this disclosure, a “research action” is action related to gathering information for an action strategy. As a non-limiting example, a research action may include ‘research a trust entity,’ ‘research a real estate entity,’ ‘research tax law,’ ‘research inheritance law,’ ‘research employment law,’ ‘research incorporate law,’ and the like. In some embodiments, action item 140 may be stored in composition database 124. In some embodiments, action item 140 may be retrieved from composition database 124.

With continued reference to FIG. 1, in some embodiments, at least a processor 108 is configured to determine action item 140 as a function of one or more composition groups 128. In some embodiments, action item 140 may be determined as a function of a goal group of one or more composition groups 128 using an action criterion. As used in this disclosure, an “action criterion” is a standard by which whether an action strategy can be generated is decided. In an embodiment, an action criterion may include a list of documentations to be submitted by a user 120. As a non-limiting example, an action criterion may include ‘W-2,’ ‘paystubs,’ ‘bank statements,’ ‘profit and loss (P&L) statements,’ ‘balance sheet,’ ‘cash flow statements,’ ‘income statements,’ ‘aging reports,’ ‘budget report,’ ‘business plan,’ and the like. In another embodiment, an action criterion may include a list of action items 140 to be submitted by a user 120. As a non-limiting example, action criterion may include ‘submit documentation,’ ‘review documentation,’ ‘a meeting with an advisor,’ ‘take composition course,’ ‘retake composition course,’ ‘research,’ and the like. In some embodiments, at least a processor 108 may include an action criterion for each of a plurality of goal groups of one or more composition groups 128. As a non-limiting example, each of a tax goal group, an investing goal group, a revenue goal group, a saving goal group, a retirement goal group, an inheritance goal group may include an action criterion. As a non-limiting example, an action criterion may include ‘submit documentation’ for a tax goal group. As another non-limiting example, an action criterion may include ‘submit documentation,’ ‘a meeting with an advisor,’ ‘take composition course,’ ‘research incorporate law’ for an investing goal group. In some embodiments, an action criterion may be input by a user 120. In some embodiments, an action criterion may be input by an advisor 120. In some embodiments, an action criterion may be stored in composition database 124. In some embodiments, an action criterion may be retrieved from composition database 124. As a non-limiting example, an action criterion may include previously used action criterion.

With continued reference to FIG. 1, in some embodiments, action item 140 may be determined as a function of composition data 116. As a non-limiting example, action item 140 may be ‘review a documentation’ for composition data 116 of document data submitted by user 120. As another non-limiting example, action item 140 may be ‘a meeting with an advisor’ for user financial information input by a user 120. As another non-limiting example, action item 140 may include ‘take a course’ for user financial information input by a user 120.

With continued reference to FIG. 1, in some embodiments, at least a processor 108 may determine action item 140 using an action machine-learning model 144. As used in this disclosure, an “action machine-learning model” is a machine-learning model that determines action item 140. In some embodiments, action machine-learning model 144 may be trained with action training data correlating composition data 116 to action item 140. As a non-limiting example, action machine-learning model 144 may determine ‘review documentation’ for submitted income statement. As another non-limiting example, action machine-learning model 144 may determine ‘take a course’ for submitted income statement. In some embodiments, action machine-learning model 144 may be trained with action training data correlating one or more composition groups 128 to action item 140. In some embodiments, action machine-learning model 144 may determine ‘a meeting with an advisor’ for a tax goal group. In some embodiments, action machine-learning model 144 may be trained with action training data correlating an action criterion to action item 140. As a non-limiting example, action machine-learning model 144 may determine action item 140 of ‘submit documentation,’ ‘a meeting with an advisor,’ ‘take composition course,’ ‘research incorporate law’ for an investing goal group when an action criterion for the investing goal group includes ‘submit documentation,’ ‘a meeting with an advisor,’ ‘take composition course,’ ‘research incorporate law.’ In some embodiments, action training data may be received from a user 120, an advisor, composition database 124, external computing devices, previous iterations of processing, and/or the like.

With continued reference to FIG. 1, in some embodiments, at least a processor 108 may determine action item 140 using an action lookup table. In an embodiment at least a processor 108 may relate one or more composition data 116 to action item 140 using an action lookup table. As a non-limiting example, at least a processor 108 may ‘lookup’ a given tax goal group to action item of ‘take a course.’ In another embodiment, at least a processor 108 may relate composition data 116 to action item 140 using an action lookup table. As a non-limiting example, at least a processor 108 may ‘lookup’ a given document data to action item 140 of ‘review a documentation.’ In some embodiments, at least a processor 108 may relate an action criterion to action item 140 using an action lookup table. As a non-limiting example, at least a processor 108 may ‘lookup’ action criterion for a tax goal group and determine action item 140 using an action lookup table.

With continued reference to FIG. 1, in some embodiments, at least a processor 108 may obtain item response. As used in this disclosure, an “item response” is any response to an action item. In an embodiment, at least a processor 108 may obtain an item response 148 from a user 120. In another embodiment, at least a processor 108 may obtain item response 148 from an advisor. As a non-limiting example, item response 148 may include a course response, a focus response, an advisor response, a document response, a research response, and the like. As used in this disclosure, a “course response” is a response related to a course action. As a non-limiting example, a course response may include a user 120 taking a composition course 136, retaking a composition course 136, skipping a composition course 136, and the like. As another non-limiting example, a course response may include an advisor adding a composition course 136, removing a composition course 136, and the like.

With continued reference to FIG. 1, as used in this disclosure, a “focus response” is a response related to a focus action. As a non-limiting example, a focus response may include choosing a focus of an action strategy 160, choosing a focus level of an action strategy 160, changing a focus of an action strategy 160, changing a focus level of an action strategy 160, and the like. As used in this disclosure, a “focus level” is a level of interest. As a non-limiting example, a focus level of an action strategy may be scored from 0 to 5, wherein 0 is the lowest interest and 5 is the highest interest. In an embodiment, a focus response may be choosing which pecuniary goal of one or more composition groups 128 is to be focused on for an action strategy 160. As a non-limiting example, a focus response may include choosing 5 as a focus level for a goal group of a tax group and choosing 0 as a focus level for a goal group of saving group. As another non-limiting example, a focus response may include choosing 4 as a focus level for a goal group of an investing group and choosing 2 as a focus level for a goal group of an inheritance group. In an embodiment, a user 120 may input focus response to at least a processor 108. In another embodiment, an advisor 120 may input focus response to at least a processor 108. In some embodiments, at least a processor 108 may obtain a focus response from a focus machine-learning model. In some embodiments, a focus machine-learning model may be trained with focus training data that correlates a pecuniary goal in one or more composition groups 128 to a focus level. As a non-limiting example, focus training data may correlate a pecuniary goal related to tax to a focus level of 5. As another non-limiting example, focus training data may correlate a pecuniary goal related to investing to a focus level of 4. In some embodiments, focus training data may be received from a user 120, an advisor, composition database 124, external computing devices, and/or previous iterations of processing. In some embodiments, focus level may be stored in composition database 124. In some embodiments, focus level may be retrieved from composition database 124.

With continued reference to FIG. 1, as used in this disclosure, an “advisor response” is a response related to an advisor action. As a non-limiting example, an advisor response may include a user 120 meeting with an advisor in person on December, amount of time a user 120 liked with an advisor on the phone on Monday, a number of times a user 120 sent an email with an advisor, and the like. As used in this disclosure, a “document response” is a response related to document action. As a non-limiting example, a document response may include a user 120 submitting a document related to tax, a user 120 submitting a document related to investing, an advisor reviewing a submitted documentation, an advisor requesting a documentation, and the like. As used in this disclosure, a “research response” is a response related to a research action. As a non-limiting example, a research response may include an advisor researching a trust entity for a user 120, an advisor researching tax law for a user 120, a user 120 researching a real estate entity, and the like.

With continued reference to FIG. 1, in some embodiments, at least a processor 108 may determine item status 152 of action item 140. As used in this disclosure, an “item status” is a status of an action item. As a non-limiting example, ‘pending,’ ‘active,’ ‘complete,’ ‘action required,’ ‘incomplete,’ and the like. As a non-limiting example, an item status 152 of action item 140 may be ‘pending’ when the action item 140 needs to be reviewed by a user 120. In an embodiment, at least a processor 108 may determine an item status 152 of action item 140 as a function of composition data 116. As a non-limiting example, an item status 152 of an action item 140 of ‘submit a tax document’ may be complete when there is composition data 116 of tax document. In some embodiments, at least a processor 108 may determine an item status 152 of action item 140 as a function of an item response 148. As another non-limiting example, an item status 152 of action item 140 may be ‘complete’ when the action item 140 is reviewed by an advisor. As another non-limiting example, an item status 152 of action item 140 may be ‘action required’ when the action item 140 needs to be reviewed by an advisor and/or a user 120 after receiving an item response 148. As another non-limiting example, action item 140 may be ‘active’ when a user 120 and/or an advisor is in the process of item response 148. As another non-limiting example, item status 152 may be ‘complete’ after receiving an item response 148 from a user 120 and/or an advisor. In some embodiments, a user 120 and/or an advisor may change item status 152 manually. In some embodiments, item status 152 may be stored in composition database 124. In some embodiments, at least a processor 108 may track item status 152.

With continued reference to FIG. 1, in some embodiments, item status 152 may include a course status. As used this disclosure, a “course status” is a status of a composition course provided to a user. In some embodiments, a course status may include a completion status of a composition course 136. As a non-limiting example, a course status may be ‘complete’ when a course response is that a user 120 took a composition course 136. As another non-limiting example, a course status may be ‘complete’ when a course response is that a user 120 passed a composition course 136. As another non-limiting example, a course status may be ‘complete’ when a course response is that a user 120 skipped a composition course 136. As another non-limiting example, a course status may be ‘incomplete’ when a course response is that a user 120 did not take a composition course 136. As another non-limiting example, a course status may be ‘incomplete’ when a course response is that a user 120 did not pass a composition course 136. In some embodiments, an item status 152 may include a focus status, advisor status, document status, research status, and the like.

With continued reference to FIG. 1, in some embodiments, at least a processor 108 may determine an item status 152 of action item 140 using a status machine-learning model 156. As used in this disclosure, a “status machine-learning model” is a machine-learning model that determines a status of an action item. In some embodiments, a status machine-learning model 156 may be trained with status training data correlating an item response 148 to an item status 152. As a non-limiting example, a status machine-learning model 156 may determine an item status 152 of an action item 140 to be ‘complete’ when an item response 148 to the action item 140 from a user 120 is ‘taking a course.’ In some embodiments, a status machine-learning model 156 may be trained with status training data correlating composition data 116 to an item status 152. As a non-limiting example, a status machine-learning model 156 may determine an action status of an action item to be complete’ when composition data 116 of document data related tax is submitted by a user 120. In some embodiments, the training data may be received from a user 120, an advisor, composition database 124, external computing devices, and/or previous iterations of processing. In some embodiments, at least a processor 108 may be configured to determine action item 140 by generating, using an action machine-learning model 144, a first action item 140, receiving, using the at least a processor 108, a course response from a user 120 for the first action item 140, determining, using a status machine-learning model 156, a completion status of a composition course 136 whether the composition course 136 is completed by the user 120, and identifying, using an action machine-learning model 144, a second action item 140 as a function of the completion status of the composition course 136.

With continued reference to FIG. 1, at least a processor 108 is configured to generate an action strategy 160. As used in this disclosure, an “action strategy” is a plan to achieve a user's goal. As a non-limiting example, action strategy 160 may include tax strategy, revenue strategy, investing strategy, saving strategy, retirement strategy, inheritance strategy. In some embodiments, at least a processor 108 may generate a plurality of action strategy 160. As a non-limiting example, at least a processor 108 may generate tax strategy, investing strategy, and retirement strategy. In some embodiments, an action strategy 160 may include a plurality of steps. As a non-limiting example, an action strategy 160 may include step 1 to 5, 1 to 3, 1 to 10, and the like, wherein 1 is a first step. As a non-limiting example, an action strategy 160 may include a step 1 for a tax strategy, a step 2 for an investing strategy, a step 3 for an inheritance strategy. As another non-limiting example, an action strategy 160 may include a step 1, 2, 3, 4, 5 for a tax strategy. In some embodiments, an advisor may manually generate an action strategy 160. In some embodiments, an action strategy may be stored in composition database 124. In some embodiments, an action strategy may be retrieved from composition database 124.

With continued reference to FIG. 1, in some embodiments, at least a processor 108 is configured to generate an action strategy 160 as a function of action item 140. In some embodiments, at least a processor 108 may generate an action strategy 160 as a function of an item status 152 of action item 140. As a non-limiting example, at least a processor 108 may generate an action strategy 160 when an item status 152 of every action item 140 is ‘complete.’ As another non-limiting example, at least a processor 108 may not generate an action strategy 160 when an item status 152 of every action item 140 is ‘incomplete.’ As another non-limiting example, at least a processor 108 may not generate an action strategy 160 when an item status of some action items 140 is ‘active.’ As another non-limiting example, at least a processor 108 may not generate an action strategy 160 when an item status 152 of some action items 140 is ‘pending’ and an item status 152 of some other action items 140 is ‘complete.’ In some embodiments, at least a processor 108 may generate an action strategy 160 as a function of an item status 152 of action item 140 and a focus level of one or more composition groups 128. As a non-limiting example, at least a processor 108 may generate an action strategy 160 when an item status 152 of an action item 140 is ‘incomplete’ and a focus level of a goal group of one or more composition groups 128 is 0. In some embodiments, at least a processor 108 may generate a plurality of steps for action strategy 160 as a function of a focus level of one or more composition groups 128. As a non-limiting example, action strategy 160 may include a step 1, wherein the step 1 is an action strategy for a pecuniary goal of a tax goal group that includes a focus level of 5, a step 2, wherein the step 2 is an action strategy for another pecuniary goal of a tax goal group that includes a focus level of 4, a step 3, wherein the step 3 is an action strategy for a pecuniary goal of an investing goal group that includes a focus level of 2.

With continued reference to FIG. 1, in some embodiments, action strategy 160 may be determined using a strategy machine-learning model 164. As used in this disclosure, a “strategy machine-learning model” is a machine-learning model that generates an action strategy. In some embodiments, a strategy machine-learning model 164 may be trained with strategy training data that correlates item status 152 to an action strategy 160. As a non-limiting example, a strategy machine-learning model 164 may determine to generate an action strategy 160 when an item status 152 of action item 140 is ‘complete.’ In some embodiments, a strategy machine-learning model 164 may be trained with strategy training data that correlates focus level to an action strategy 160. As a non-limiting example, a strategy machine-learning model 164 may determine to generate an action strategy 160 when a focus level of one or more composition groups 128 is 0. As another non-limiting example, a strategy machine-learning model 160 may determine to generate a plurality of steps for an action strategy 160 when one or more composition groups 128 includes a plurality of focus levels. In some embodiments, strategy training data may be received from an advisor, composition database 124, external computing devices, and/or previous iterations of processing.

With continued reference to FIG. 1, in some embodiments, generating action strategy 160 may include generating a report. As used in this disclosure, a “report” is information gathered through in an embodiment, a report may graphically represent composition data 116. In another embodiment, a report may graphically represent one or more composition groups 128. In some embodiments, a report may graphically represent action strategy 160. As a non-limiting example, a report may include a flow diagram, a graph, a text report, an image, a chart, a video, an audio, and the like. As another non-limiting example, a report may include a flow diagram of cash reserves, a flow diagram of profit development, a strategy map for investing. As another non-limiting example, a report may include a chart of one or more composition groups 128. As another non-limiting example, a report may include a list of action strategies 160 taken for a user 120. As another non-limiting example, a report may include a list of action strategies 160 that will be proceeded in the future. In some embodiments, at least a processor 108 may generate a report using a graph machine-learning model. As used in this disclosure, a “graph machine-learning model” is a machine-learning model that generates a graph. In some embodiments, a graph machine-learning model may be trained with graph training data that receives data and generates a graph with the data. In some embodiments, graph training data may receive composition data 116, composition groups 128, composition course 136, action strategy 160, and the like. In some embodiments, graph training data may be received from a user 120, an advisor, composition database 124, external computing devices, and/or previous iterations of processing.

With continued reference to FIG. 1, system 100 includes a strategy database 124. In some embodiments, strategy database 124 may include composition data 116, composition group 128, composition course 136, action item 140, action strategy 160, a recent activity, and the like. Database may be implemented, without limitation, as a relational database, a key-value retrieval database such as a NOSQL database, or any other format or structure for use as a database that a person skilled in the art would recognize as suitable upon review of the entirety of this disclosure. Database may alternatively or additionally be implemented using a distributed data storage protocol and/or data structure, such as a distributed hash table or the like. Database may include a plurality of data entries and/or records as described above. Data entries in a database may be flagged with or linked to one or more additional elements of information, which may be reflected in data entry cells and/or in linked tables such as tables related by one or more indices in a relational database. Persons skilled in the art, upon reviewing the entirety of this disclosure, will be aware of various ways in which data entries in a database may store, retrieve, organize, and/or reflect data and/or records as used herein, as well as categories and/or populations of data consistently with this disclosure.

In some embodiments, and with further reference to FIG. 1, generation of action strategy may include and/or be supported by cross-product content integration. Apparatus and/or system may integrate external educational resources such as without limitation archived live sessions, courses, and proprietary learning materials into generation of action strategy, action items, or the like as described above. For instance, and for the purposes of illustration, as users progress through financial or tax strategies, AI models and/or components as described in this disclosure may retrieve and/or provide relevant deep-dive materials or related educational topics from third-party products. It may also recommend premium educational experiences such as conferences or seminars aligned with user goals. Existing self-guided planning systems are frequently siloed and limited to static content within a single platform, reducing user engagement and educational depth. Embodiments of apparatus and/or system may utilize AI-driven content linking, to dynamically identify and/or retrieve supplemental material aligned with user goals and focus areas. Training on archived materials enables contextual recommendations, creating a more holistic and engaging experience. This improves user retention, learning outcomes, and offers natural upsell opportunities aligned with user interests.

In some embodiments, and still referring to FIG. 1, apparatus may include a recommendation model integrated with strategy and focus ML models. Recommendation model may include, without limitation, an encoder, such as without limitation a large language model encoder as described in further detail below; recommendation model may convert one or more elements of data into vectors, which may be compared geometrically and/or by a comparison model, such as without limitation classifier and/or a encoder such as a BERT followed by a stage and/or module for comparison and/or classification of embeddings to determine similarity and/or mutual relevance of data. Recommendation module may employ vectorization and similarity scoring on archived materials. Model, models, and/or stages thereof may support multimodal retrieval, for instance of text, video, and/or audio data. In an embodiment, individual media type-specific neural networks, models and/or stages may generate outputs such as embeddings or other encodings that may be compared to one another by and/or ingested by a subsequent stage, which may include a decoder stage, a classifier, or the like. Such models and/or suites may integrate with APIs and/or streams of data from third-party devices and/or services to generate recommendations or other outputs. In an embodiment, recommendation engine may track engagement for continuous recommendation and/or improvement tracking.

Continuing to refer to FIG. 1, in some embodiments apparatus and/or system may be configured to generate context-aware summaries and/or AI-enhanced feedback reports. In some embodiments, feedback reports may include factual determinations, retrieved data, and/or calculated data; as a non-limiting example, one or more calculation tools may be configured to estimate potential tax savings and/or goal achievement outcomes. A neural network and/or machine-learning model such as without limitation an LLM may be configured to enhance such outputs and/or summaries by analyzing user inputs received prior to, during, and/or after production of such outputs, and expanding them into contextual, personalized feedback reports, for instance by using such user inputs and summaries and/or other outputs to generate predicted tokens forming such reports. These reports may provide ongoing insights, highlight areas for improvement, and can serve as discussion materials for human advisors. Conventional reporting tools produce static summaries that lack personalized context and ongoing feedback mechanisms. In some embodiments, machine-learning models such as without limitation neural networks, which may include LLMs, may be used to transform numeric summaries into narrative feedback using contextual analysis, helping users understand their progress and motivating continued engagement. Reports may be periodically updated and integrated with advisor collaboration tools for hybrid user-advisor experiences. In some embodiment, feedback engines may be linked with proprietary calculation modules. Natural language generation (NLG) models such as language processing modules and/or models, and/or LLMs, and/or combinations thereof, may generate narrative summaries from structured data. Context inference layers, models, and/or stages may identify key behavioral insights, for instance and without limitation as described above. Such methods and/or components may support and/or be incorporate in recurring report generation at periodic and/or strategic intervals, and/or upon receipt of inputs from a user as described above. Output may be generated at a user interface for a user and/or a user interface generated for an advisor.

Referring now to FIG. 2, an exemplary embodiment of a machine-learning module 200 that may perform one or more machine-learning processes as described in this disclosure is illustrated. Machine-learning module may perform determinations, classification, and/or analysis steps, methods, processes, or the like as described in this disclosure using machine learning processes. A “machine learning process,” as used in this disclosure, is a process that automatedly uses training data 204 to generate an algorithm instantiated in hardware or software logic, data structures, and/or functions that will be performed by a computing device/module to produce outputs 208 given data provided as inputs 212; this is in contrast to a non-machine learning software program where the commands to be executed are determined in advance by a user and written in a programming language.

Still referring to FIG. 2, “training data,” as used herein, is data containing correlations that a machine-learning process may use to model relationships between two or more categories of data elements. For instance, and without limitation, training data 204 may include a plurality of data entries, also known as “training examples,” each entry representing a set of data elements that were recorded, received, and/or generated together; data elements may be correlated by shared existence in a given data entry, by proximity in a given data entry, or the like. Multiple data entries in training data 204 may evince one or more trends in correlations between categories of data elements; for instance, and without limitation, a higher value of a first data element belonging to a first category of data element may tend to correlate to a higher value of a second data element belonging to a second category of data element, indicating a possible proportional or other mathematical relationship linking values belonging to the two categories. Multiple categories of data elements may be related in training data 204 according to various correlations; correlations may indicate causative and/or predictive links between categories of data elements, which may be modeled as relationships such as mathematical relationships by machine-learning processes as described in further detail below. Training data 204 may be formatted and/or organized by categories of data elements, for instance by associating data elements with one or more descriptors corresponding to categories of data elements. As a non-limiting example, training data 204 may include data entered in standardized forms by persons or processes, such that entry of a given data element in a given field in a form may be mapped to one or more descriptors of categories. Elements in training data 204 may be linked to descriptors of categories by tags, tokens, or other data elements; for instance, and without limitation, training data 204 may be provided in fixed-length formats, formats linking positions of data to categories such as comma-separated value (CSV) formats and/or self-describing formats such as extensible markup language (XML), JavaScript Object Notation (JSON), or the like, enabling processes or devices to detect categories of data.

Alternatively or additionally, and continuing to refer to FIG. 2, training data 204 may include one or more elements that are not categorized; that is, training data 204 may not be formatted or contain descriptors for some elements of data. Machine-learning algorithms and/or other processes may sort training data 204 according to one or more categorizations using, for instance, natural language processing algorithms, tokenization, detection of correlated values in raw data and the like; categories may be generated using correlation and/or other processing algorithms. As a non-limiting example, in a corpus of text, phrases making up a number “n” of compound words, such as nouns modified by other nouns, may be identified according to a statistically significant prevalence of n-grams containing such words in a particular order; such an n-gram may be categorized as an element of language such as a “word” to be tracked similarly to single words, generating a new category as a result of statistical analysis. Similarly, in a data entry including some textual data, a person's name may be identified by reference to a list, dictionary, or other compendium of terms, permitting ad-hoc categorization by machine-learning algorithms, and/or automated association of data in the data entry with descriptors or into a given format. The ability to categorize data entries automatedly may enable the same training data 204 to be made applicable for two or more distinct machine-learning algorithms as described in further detail below. Training data 204 used by machine-learning module 200 may correlate any input data as described in this disclosure to any output data as described in this disclosure.

Further referring to FIG. 2, training data may be filtered, sorted, and/or selected using one or more supervised and/or unsupervised machine-learning processes and/or models as described in further detail below; such models may include without limitation a training data classifier 216. Training data classifier 216 may include a “classifier,” which as used in this disclosure is a machine-learning model as defined below, such as a data structure representing and/or using a mathematical model, neural net, or program generated by a machine learning algorithm known as a “classification algorithm,” as described in further detail below, that sorts inputs into categories or bins of data, outputting the categories or bins of data and/or labels associated therewith. A classifier may be configured to output at least a datum that labels or otherwise identifies a set of data that are clustered together, found to be close under a distance metric as described below, or the like. A distance metric may include any norm, such as, without limitation, a Pythagorean norm. Machine-learning module 200 may generate a classifier using a classification algorithm, defined as a processes whereby a computing device and/or any module and/or component operating thereon derives a classifier from training data 204. Classification may be performed using, without limitation, linear classifiers such as without limitation logistic regression and/or naive Bayes classifiers, nearest neighbor classifiers such as k-nearest neighbors classifiers, support vector machines, least squares support vector machines, fisher's linear discriminant, quadratic classifiers, decision trees, boosted trees, random forest classifiers, learning vector quantization, and/or neural network-based classifiers. As a non-limiting example, training data classifier 216 may classify elements of training data to types of users, composition groups, goal groups, and/or other groupings, cluster centroids, and/or categories of data and/or users as described in this disclosure.

Still referring to FIG. 2, a computing device may be configured to generate a classifier using a Naïve Bayes classification algorithm. Naïve Bayes classification algorithm generates classifiers by assigning class labels to problem instances, represented as vectors of element values. Class labels are drawn from a finite set. Naïve Bayes classification algorithm may include generating a family of algorithms that assume that the value of a particular element is independent of the value of any other element, given a class variable. Naïve Bayes classification algorithm may be based on Bayes Theorem expressed as P(A/B)=P(B/A)P(A)=P(B), where P(A/B) is the probability of hypothesis A given data B also known as posterior probability; P(B/A) is the probability of data B given that the hypothesis A was true; P(A) is the probability of hypothesis A being true regardless of data also known as prior probability of A; and P(B) is the probability of the data regardless of the hypothesis. A naïve Bayes algorithm may be generated by first transforming training data into a frequency table. Computing device may then calculate a likelihood table by calculating probabilities of different data entries and classification labels. A computing device may utilize a naïve Bayes equation to calculate a posterior probability for each class. A class containing the highest posterior probability is the outcome of prediction. Naïve Bayes classification algorithm may include a gaussian model that follows a normal distribution. Naïve Bayes classification algorithm may include a multinomial model that is used for discrete counts. Naïve Bayes classification algorithm may include a Bernoulli model that may be utilized when vectors are binary.

With continued reference to FIG. 2, a computing device may be configured to generate a classifier using a K-nearest neighbors (KNN) algorithm. A “K-nearest neighbors algorithm” as used in this disclosure, includes a classification method that utilizes feature similarity to analyze how closely out-of-sample-features resemble training data to classify input data to one or more clusters and/or categories of features as represented in training data; this may be performed by representing both training data and input data in vector forms, and using one or more measures of vector similarity to identify classifications within training data, and to determine a classification of input data. K-nearest neighbors algorithm may include specifying a K-value, or a number directing the classifier to select the k most similar entries training data to a given sample, determining the most common classifier of the entries in the database, and classifying the known sample; this may be performed recursively and/or iteratively to generate a classifier that may be used to classify input data as further samples. For instance, an initial set of samples may be performed to cover an initial heuristic and/or “first guess” at an output and/or relationship, which may be seeded, without limitation, using expert input received according to any process as described herein. As a non-limiting example, an initial heuristic may include a ranking of associations between inputs and elements of training data. Heuristic may include selecting some number of highest-ranking associations and/or training data elements.

With continued reference to FIG. 2, generating k-nearest neighbors algorithm may generate a first vector output containing a data entry cluster, generating a second vector output containing an input data, and calculate the distance between the first vector output and the second vector output using any suitable norm such as cosine similarity, Euclidean distance measurement, or the like. Each vector output may be represented, without limitation, as an n-tuple of values, where n is at least two values. Each value of n-tuple of values may represent a measurement or other quantitative value associated with a given category of data, or attribute, examples of which are provided in further detail below; a vector may be represented, without limitation, in n-dimensional space using an axis per category of value represented in n-tuple of values, such that a vector has a geometric direction characterizing the relative quantities of attributes in the n-tuple as compared to each other. Two vectors may be considered equivalent where their directions, and/or the relative quantities of values within each vector as compared to each other, are the same; thus, as a non-limiting example, a vector represented as [5, 10, 15] may be treated as equivalent, for purposes of this disclosure, as a vector represented as [1, 2, 3]. Vectors may be more similar where their directions are more similar, and more different where their directions are more divergent; however, vector similarity may alternatively or additionally be determined using averages of similarities between like attributes, or any other measure of similarity suitable for any n-tuple of values, or aggregation of numerical similarity measures for the purposes of loss functions as described in further detail below. Any vectors as described herein may be scaled, such that each vector represents each attribute along an equivalent scale of values. Each vector may be “normalized,” or divided by a “length” attribute, such as a length attribute/as derived using a Pythagorean norm: l=\sqrt{Σᵢ₌₀ⁿaᵢ²}, where aᵢ is attribute number i of the vector. Scaling and/or normalization may function to make vector comparison independent of absolute quantities of attributes, while preserving any dependency on similarity of attributes; this may, for instance, be advantageous where cases represented in training data are represented by different quantities of samples, which may result in proportionally equivalent vectors with divergent values.

With further reference to FIG. 2, training examples for use as training data may be selected from a population of potential examples according to cohorts relevant to an analytical problem to be solved, a classification task, or the like. Alternatively or additionally, training data may be selected to span a set of likely circumstances or inputs for a machine-learning model and/or process to encounter when deployed. For instance, and without limitation, for each category of input data to a machine-learning process or model that may exist in a range of values in a population of phenomena such as images, user data, process data, physical data, or the like, a computing device, processor, and/or machine-learning model may select training examples representing each possible value on such a range and/or a representative sample of values on such a range. Selection of a representative sample may include selection of training examples in proportions matching a statistically determined and/or predicted distribution of such values according to relative frequency, such that, for instance, values encountered more frequently in a population of data so analyzed are represented by more training examples than values that are encountered less frequently. Alternatively or additionally, a set of training examples may be compared to a collection of representative values in a database and/or presented to a user, so that a process can detect, automatically or via user input, one or more values that are not included in the set of training examples. A computing device, processor, and/or module may automatically generate a missing training example; this may be done by receiving and/or retrieving a missing input and/or output value and correlating the missing input and/or output value with a corresponding output and/or input value collocated in a data record with the retrieved value, provided by a user and/or other device, or the like.

Continuing to refer to FIG. 2, computer, processor, and/or module may be configured to preprocess training data. “Preprocessing” training data, as used in this disclosure, is transforming training data from raw form to a format that can be used for training a machine learning model. Preprocessing may include sanitizing, feature selection, feature scaling, data augmentation and the like.

Still referring to FIG. 2, computer, processor, and/or module may be configured to sanitize training data. “Sanitizing” training data, as used in this disclosure, is a process whereby training examples are removed that interfere with convergence of a machine-learning model and/or process to a useful result. For instance, and without limitation, a training example may include an input and/or output value that is an outlier from typically encountered values, such that a machine-learning algorithm using the training example will be adapted to an unlikely amount as an input and/or output; a value that is more than a threshold number of standard deviations away from an average, mean, or expected value, for instance, may be eliminated. Alternatively or additionally, one or more training examples may be identified as having poor quality data, where “poor quality” is defined as having a signal to noise ratio below a threshold value. Sanitizing may include steps such as removing duplicative or otherwise redundant data, interpolating missing data, correcting data errors, standardizing data, identifying outliers, and the like. In a nonlimiting example, sanitization may include utilizing algorithms for identifying duplicate entries or spell-check algorithms.

As a non-limiting example, and with further reference to FIG. 2, images used to train an image classifier or other machine-learning model and/or process that takes images as inputs or generates images as outputs may be rejected if image quality is below a threshold value. For instance, and without limitation, computing device, processor, and/or module may perform blur detection, and eliminate one or more Blur detection may be performed, as a non-limiting example, by taking Fourier transform, or an approximation such as a Fast Fourier Transform (FFT) of the image and analyzing a distribution of low and high frequencies in the resulting frequency-domain depiction of the image; numbers of high-frequency values below a threshold level may indicate blurriness. As a further non-limiting example, detection of blurriness may be performed by convolving an image, a channel of an image, or the like with a Laplacian kernel; this may generate a numerical score reflecting a number of rapid changes in intensity shown in the image, such that a high score indicates clarity and a low score indicates blurriness. Blurriness detection may be performed using a gradient-based operator, which measures operators based on the gradient or first derivative of an image, based on the hypothesis that rapid changes indicate sharp edges in the image, and thus are indicative of a lower degree of blurriness. Blur detection may be performed using Wavelet-based operator, which takes advantage of the capability of coefficients of the discrete wavelet transform to describe the frequency and spatial content of images. Blur detection may be performed using statistics-based operators take advantage of several image statistics as texture descriptors in order to compute a focus level. Blur detection may be performed by using discrete cosine transform (DCT) coefficients in order to compute a focus level of an image from its frequency content.

Continuing to refer to FIG. 2, computing device, processor, and/or module may be configured to precondition one or more training examples. For instance, and without limitation, where a machine learning model and/or process has one or more inputs and/or outputs requiring, transmitting, or receiving a certain number of bits, samples, or other units of data, one or more training examples' elements to be used as or compared to inputs and/or outputs may be modified to have such a number of units of data. For instance, a computing device, processor, and/or module may convert a smaller number of units, such as in a low pixel count image, into a desired number of units, for instance by upsampling and interpolating. As a non-limiting example, a low pixel count image may have 100 pixels, however a desired number of pixels may be 128. Processor may interpolate the low pixel count image to convert the 100 pixels into 128 pixels. It should also be noted that one of ordinary skill in the art, upon reading this disclosure, would know the various methods to interpolate a smaller number of data units such as samples, pixels, bits, or the like to a desired number of such units. In some instances, a set of interpolation rules may be trained by sets of highly detailed inputs and/or outputs and corresponding inputs and/or outputs downsampled to smaller numbers of units, and a neural network or other machine learning model that is trained to predict interpolated pixel values using the training data. As a non-limiting example, a sample input and/or output, such as a sample picture, with sample-expanded data units (e.g., pixels added between the original pixels) may be input to a neural network or machine-learning model and output a pseudo replica sample-picture with dummy values assigned to pixels between the original pixels based on a set of interpolation rules. As a non-limiting example, in the context of an image classifier, a machine-learning model may have a set of interpolation rules trained by sets of highly detailed images and images that have been downsampled to smaller numbers of pixels, and a neural network or other machine learning model that is trained using those examples to predict interpolated pixel values in a facial picture context. As a result, an input with sample-expanded data units (the ones added between the original data units, with dummy values) may be run through a trained neural network and/or model, which may fill in values to replace the dummy values. Alternatively or additionally, processor, computing device, and/or module may utilize sample expander methods, a low-pass filter, or both. As used in this disclosure, a “low-pass filter” is a filter that passes signals with a frequency lower than a selected cutoff frequency and attenuates signals with frequencies higher than the cutoff frequency. The exact frequency response of the filter depends on the filter design. Computing device, processor, and/or module may use averaging, such as luma or chroma averaging in images, to fill in data units in between original data units.

In some embodiments, and with continued reference to FIG. 2, computing device, processor, and/or module may down-sample elements of a training example to a desired lower number of data elements. As a non-limiting example, a high pixel count image may have 256 pixels, however a desired number of pixels may be 128. Processor may down-sample the high pixel count image to convert the 256 pixels into 128 pixels. In some embodiments, processor may be configured to perform downsampling on data. Downsampling, also known as decimation, may include removing every Nth entry in a sequence of samples, all but every Nth entry, or the like, which is a process known as “compression,” and may be performed, for instance by an N-sample compressor implemented using hardware or software. Anti-aliasing and/or anti-imaging filters, and/or low-pass filters, may be used to clean up side-effects of compression.

Further referring to FIG. 2, feature selection includes narrowing and/or filtering training data to exclude features and/or elements, or training data including such elements, that are not relevant to a purpose for which a trained machine-learning model and/or algorithm is being trained, and/or collection of features and/or elements, or training data including such elements, on the basis of relevance or utility for an intended task or purpose for a trained machine-learning model and/or algorithm is being trained. Feature selection may be implemented, without limitation, using any process described in this disclosure, including without limitation using training data classifiers, exclusion of outliers, or the like.

With continued reference to FIG. 2, feature scaling may include, without limitation, normalization of data entries, which may be accomplished by dividing numerical fields by norms thereof, for instance as performed for vector normalization. Feature scaling may include absolute maximum scaling, wherein each quantitative datum is divided by the maximum absolute value of all quantitative data of a set or subset of quantitative data. Feature scaling may include min-max scaling, in which each value X has a minimum value Xₘᵢₙ in a set or subset of values subtracted therefrom, with the result divided by the range of the values, give maximum value in the set or subset

$${X}_{max} : {X}_{new} = \frac{X - {X}_{min}}{{X}_{max} - {X}_{min}} .$$

Feature scaling may include mean normalization, which involves use of a mean value of a set and/or subset of values, Xₘₑₐₙ with maximum and minimum values:

$${X}_{new} = \frac{X - {X}_{mean}}{{X}_{max} - {X}_{min}} .$$

Feature scaling may include standardization, where a difference between X and Xₘₑₐₙ is divided by a standard deviation σ of a set or subset of values:

$${X}_{new} = \frac{X - {X}_{mean}}{σ} .$$

Scaling may be performed using a median value of a a set or subset X_{median} and/or interquartile range (IQR), which represents the difference between the 25^{th} percentile value and the 50^{th} percentile value (or closest values thereto by a rounding protocol), such as:

$${X}_{new} = \frac{X - {X}_{median}}{IQR} .$$

Persons skilled in the art, upon reviewing the entirety of this disclosure, will be aware of various alternative or additional approaches that may be used for feature scaling.

Further referring to FIG. 2, computing device, processor, and/or module may be configured to perform one or more processes of data augmentation. “Data augmentation” as used in this disclosure is addition of data to a training set using elements and/or entries already in the dataset. Data augmentation may be accomplished, without limitation, using interpolation, generation of modified copies of existing entries and/or examples, and/or one or more generative AI processes, for instance using deep neural networks and/or generative adversarial networks; generative processes may be referred to alternatively in this context as “data synthesis” and as creating “synthetic data.” Augmentation may include performing one or more transformations on data, such as geometric, color space, affine, brightness, cropping, and/or contrast transformations of images.

Still referring to FIG. 2, machine-learning module 200 may be configured to perform a lazy-learning process 220 and/or protocol, which may alternatively be referred to as a “lazy loading” or “call-when-needed” process and/or protocol, may be a process whereby machine learning is conducted upon receipt of an input to be converted to an output, by combining the input and training set to derive the algorithm to be used to produce the output on demand. For instance, an initial set of simulations may be performed to cover an initial heuristic and/or “first guess” at an output and/or relationship. As a non-limiting example, an initial heuristic may include a ranking of associations between inputs and elements of training data 204. Heuristic may include selecting some number of highest-ranking associations and/or training data 204 elements. Lazy learning may implement any suitable lazy learning algorithm, including without limitation a K-nearest neighbors algorithm, a lazy naïve Bayes algorithm, or the like; persons skilled in the art, upon reviewing the entirety of this disclosure, will be aware of various lazy-learning algorithms that may be applied to generate outputs as described in this disclosure, including without limitation lazy learning applications of machine-learning algorithms as described in further detail below.

Alternatively or additionally, and with continued reference to FIG. 2, machine-learning processes as described in this disclosure may be used to generate machine-learning models 224. A “machine-learning model,” as used in this disclosure, is a data structure representing and/or instantiating a mathematical and/or algorithmic representation of a relationship between inputs and outputs, as generated using any machine-learning process including without limitation any process as described above, and stored in memory; an input is submitted to a machine-learning model 224 once created, which generates an output based on the relationship that was derived. For instance, and without limitation, a linear regression model, generated using a linear regression algorithm, may compute a linear combination of input data using coefficients derived during machine-learning processes to calculate an output datum. As a further non-limiting example, a machine-learning model 224 may be generated by creating an artificial neural network, such as a convolutional neural network comprising an input layer of nodes, one or more intermediate layers, and an output layer of nodes. Connections between nodes may be created via the process of “training” the network, in which elements from a training data 204 set are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning.

Still referring to FIG. 2, machine-learning algorithms may include at least a supervised machine-learning process 228. At least a supervised machine-learning process 228, as defined herein, include algorithms that receive a training set relating a number of inputs to a number of outputs, and seek to generate one or more data structures representing and/or instantiating one or more mathematical relations relating inputs to outputs, where each of the one or more mathematical relations is optimal according to some criterion specified to the algorithm using some scoring function. For instance, a supervised learning algorithm may include inputs as described in this disclosure as inputs, outputs as described in this disclosure as outputs, and a scoring function representing a desired form of relationship to be detected between inputs and outputs; scoring function may, for instance, seek to maximize the probability that a given input and/or combination of elements inputs is associated with a given output to minimize the probability that a given input is not associated with a given output. Scoring function may be expressed as a risk function representing an “expected loss” of an algorithm relating inputs to outputs, where loss is computed as an error function representing a degree to which a prediction generated by the relation is incorrect when compared to a given input-output pair provided in training data 204. Persons skilled in the art, upon reviewing the entirety of this disclosure, will be aware of various possible variations of at least a supervised machine-learning process 228 that may be used to determine relation between inputs and outputs. Supervised machine-learning processes may include classification algorithms as defined above.

With further reference to FIG. 2, training a supervised machine-learning process may include, without limitation, iteratively updating coefficients, biases, weights based on an error function, expected loss, and/or risk function. For instance, an output generated by a supervised machine-learning model using an input example in a training example may be compared to an output example from the training example; an error function may be generated based on the comparison, which may include any error function suitable for use with any machine-learning algorithm described in this disclosure, including a square of a difference between one or more sets of compared values or the like. Such an error function may be used in turn to update one or more weights, biases, coefficients, or other parameters of a machine-learning model through any suitable process including without limitation gradient descent processes, least-squares processes, and/or other processes described in this disclosure. This may be done iteratively and/or recursively to gradually tune such weights, biases, coefficients, or other parameters. Updating may be performed, in neural networks, using one or more back-propagation algorithms. Iterative and/or recursive updates to weights, biases, coefficients, or other parameters as described above may be performed until currently available training data is exhausted and/or until a convergence test is passed, where a “convergence test” is a test for a condition selected as indicating that a model and/or weights, biases, coefficients, or other parameters thereof has reached a degree of accuracy. A convergence test may, for instance, compare a difference between two or more successive errors or error function values, where differences below a threshold amount may be taken to indicate convergence. Alternatively or additionally, one or more errors and/or error function values evaluated in training iterations may be compared to a threshold.

Continuing to refer to FIG. 2, evaluation of error function and/or other comparison results may include comparison of each of error function and/or other comparison results to a maximum single error threshold; in other words, a criterion of evaluation may include performing iterative retraining if any single comparison and/or error function output exceeds maximum single error threshold or if a count of single comparison and/or error function outputs exceeding single error threshold exceeds a threshold number and/or proportion of overall error function and/or other comparison results. Alternatively or additionally, evaluation of error function and/or other comparison results may include comparison of an aggregated plurality of error function and/or other comparison results to an aggregate error threshold; in other words, a criterion of evaluation may include performing iterative retraining if a result of averaging or otherwise aggregating a plurality such as some or all evaluated function and/or other comparison results exceeds aggregate error threshold. Aggregation may be performed in any manner of aggregation described in this disclosure and/or any combination thereof. Criteria for evaluations may be evaluated separately such that failing any one criterion causes iterative retraining; alternatively or additionally evaluation results may be combined according to one or more logical or other rules.

As a non-limiting, illustrative example, and still referring to FIG. 2, where outputs to be compared by error function are numerical values, error function may include subtraction of one from the other to derive an absolute value and/or mean squared error. Where outputs and/or training examples are represented as a binary classification, an error function may include a hinge loss function, sigmoid cross entropy loss function, weighted cross entropy loss function, or the like. Where output and/or exemplary output in a training set is a classification to three or more values, error function may include a softmax cross entropy loss function, a sparse cross entropy loss function, a Kullback-Leibler divergence loss function, or the like. Where both retaining and training with include supervised training, retraining may use a different error function, different weight update functions and/or parameters, or the like than in the training stage. For instance, and without limitation, when a previous iterative retraining process included training using examples from until a first convergence threshold and/or epsilon value and/or neighborhood is met, a subsequent iterative retraining process may include a lower convergence threshold, a smaller value of epsilon, or the like. Iterative retraining may include using one or more examples that were not used in any previous training and/or retraining process; for instance, where convergence was initially and/or previously achieved using a first subset of examples a subsequent retraining process may use examples from a second subset of examples, which may be wholly disjoint from first subset and/or have one or more elements that are not found in first subset.

Still referring to FIG. 2, a computing device, processor, and/or module may be configured to perform method, method step, sequence of method steps and/or algorithm described in reference to this figure, in any order and with any degree of repetition. For instance, a computing device, processor, and/or module may be configured to perform a single step, sequence and/or algorithm repeatedly until a desired or commanded outcome is achieved; repetition of a step or a sequence of steps may be performed iteratively and/or recursively using outputs of previous repetitions as inputs to subsequent repetitions, aggregating inputs and/or outputs of repetitions to produce an aggregate result, reduction or decrement of one or more variables such as global variables, and/or division of a larger processing task into a set of iteratively addressed smaller processing tasks. A computing device, processor, and/or module may perform any step, sequence of steps, or algorithm in parallel, such as simultaneously and/or substantially simultaneously performing a step two or more times using two or more parallel threads, processor cores, or the like; division of tasks between parallel threads and/or processes may be performed according to any protocol suitable for division of tasks between iterations. Persons skilled in the art, upon reviewing the entirety of this disclosure, will be aware of various ways in which steps, sequences of steps, processing tasks, and/or data may be subdivided, shared, or otherwise dealt with using iteration, recursion, and/or parallel processing.

Further referring to FIG. 2, machine learning processes may include at least an unsupervised machine-learning processes 232. An unsupervised machine-learning process, as used herein, is a process that derives inferences in datasets without regard to labels; as a result, an unsupervised machine-learning process may be free to discover any structure, relationship, and/or correlation provided in the data. Unsupervised processes 232 may not require a response variable; unsupervised processes 232 may be used to find interesting patterns and/or inferences between variables, to determine a degree of correlation between two or more variables, or the like.

Still referring to FIG. 2, machine-learning module 200 may be designed and configured to create a machine-learning model 224 using techniques for development of linear regression models. Linear regression models may include ordinary least squares regression, which aims to minimize the square of the difference between predicted outcomes and actual outcomes according to an appropriate norm for measuring such a difference (e.g. a vector-space distance norm); coefficients of the resulting linear equation may be modified to improve minimization. Linear regression models may include ridge regression methods, where the function to be minimized includes the least-squares function plus term multiplying the square of each coefficient by a scalar amount to penalize large coefficients. Linear regression models may include least absolute shrinkage and selection operator (LASSO) models, in which ridge regression is combined with multiplying the least-squares term by a factor of 1 divided by double the number of samples. Linear regression models may include a multi-task lasso model wherein the norm applied in the least-squares term of the lasso model is the Frobenius norm amounting to the square root of the sum of squares of all terms. Linear regression models may include the elastic net model, a multi-task elastic net model, a least angle regression model, a LARS lasso model, an orthogonal matching pursuit model, a Bayesian regression model, a logistic regression model, a stochastic gradient descent model, a perceptron model, a passive aggressive algorithm, a robustness regression model, a Huber regression model, or any other suitable model that may occur to persons skilled in the art upon reviewing the entirety of this disclosure. Linear regression models may be generalized in an embodiment to polynomial regression models, whereby a polynomial equation (e.g. a quadratic, cubic or higher-order equation) providing a best predicted output/actual output fit is sought; similar methods to those described above may be applied to minimize error functions, as will be apparent to persons skilled in the art upon reviewing the entirety of this disclosure.

Continuing to refer to FIG. 2, machine-learning algorithms may include, without limitation, linear discriminant analysis. Machine-learning algorithm may include quadratic discriminant analysis. Machine-learning algorithms may include kernel ridge regression. Machine-learning algorithms may include support vector machines, including without limitation support vector classification-based regression processes. Machine-learning algorithms may include stochastic gradient descent algorithms, including classification and regression algorithms based on stochastic gradient descent. Machine-learning algorithms may include nearest neighbors algorithms. Machine-learning algorithms may include various forms of latent space regularization such as variational regularization. Machine-learning algorithms may include Gaussian processes such as Gaussian Process Regression. Machine-learning algorithms may include cross-decomposition algorithms, including partial least squares and/or canonical correlation analysis. Machine-learning algorithms may include naïve Bayes methods. Machine-learning algorithms may include algorithms based on decision trees, such as decision tree classification or regression algorithms. Machine-learning algorithms may include ensemble methods such as bagging meta-estimator, forest of randomized trees, AdaBoost, gradient tree boosting, and/or voting classifier methods. Machine-learning algorithms may include neural net algorithms, including convolutional neural net processes.

Still referring to FIG. 2, a machine-learning model and/or process may be deployed or instantiated by incorporation into a program, apparatus, system and/or module. For instance, and without limitation, a machine-learning model, neural network, and/or some or all parameters thereof may be stored and/or deployed in any memory or circuitry. Parameters such as coefficients, weights, and/or biases may be stored as circuit-based constants, such as arrays of wires and/or binary inputs and/or outputs set at logic “1” and “0” voltage levels in a logic circuit to represent a number according to any suitable encoding system including twos complement or the like or may be stored in any volatile and/or non-volatile memory. Similarly, mathematical operations and input and/or output of data to or from models, neural network layers, or the like may be instantiated in hardware circuitry and/or in the form of instructions in firmware, machine-code such as binary operation code instructions, assembly language, or any higher-order programming language. Any technology for hardware and/or software instantiation of memory, instructions, data structures, and/or algorithms may be used to instantiate a machine-learning process and/or model, including without limitation any combination of production and/or configuration of non-reconfigurable hardware elements, circuits, and/or modules such as without limitation ASICs, production and/or configuration of reconfigurable hardware elements, circuits, and/or modules such as without limitation FPGAs, production and/or of non-reconfigurable and/or configuration non-rewritable memory elements, circuits, and/or modules such as without limitation non-rewritable ROM, production and/or configuration of reconfigurable and/or rewritable memory elements, circuits, and/or modules such as without limitation rewritable ROM or other memory technology described in this disclosure, and/or production and/or configuration of any computing device and/or component thereof as described in this disclosure. Such deployed and/or instantiated machine-learning model and/or algorithm may receive inputs from any other process, module, and/or component described in this disclosure, and produce outputs to any other process, module, and/or component described in this disclosure.

Continuing to refer to FIG. 2, any process of training, retraining, deployment, and/or instantiation of any machine-learning model and/or algorithm may be performed and/or repeated after an initial deployment and/or instantiation to correct, refine, and/or improve the machine-learning model and/or algorithm. Such retraining, deployment, and/or instantiation may be performed as a periodic or regular process, such as retraining, deployment, and/or instantiation at regular elapsed time periods, after some measure of volume such as a number of bytes or other measures of data processed, a number of uses or performances of processes described in this disclosure, or the like, and/or according to a software, firmware, or other update schedule. Alternatively or additionally, retraining, deployment, and/or instantiation may be event-based, and may be triggered, without limitation, by user inputs indicating sub-optimal or otherwise problematic performance and/or by automated field testing and/or auditing processes, which may compare outputs of machine-learning models and/or algorithms, and/or errors and/or error functions thereof, to any thresholds, convergence tests, or the like, and/or may compare outputs of processes described herein to similar thresholds, convergence tests or the like. Event-based retraining, deployment, and/or instantiation may alternatively or additionally be triggered by receipt and/or generation of one or more new training examples; a number of new training examples may be compared to a preconfigured threshold, where exceeding the preconfigured threshold may trigger retraining, deployment, and/or instantiation.

Still referring to FIG. 2, retraining and/or additional training may be performed using any process for training described above, using any currently or previously deployed version of a machine-learning model and/or algorithm as a starting point. Training data for retraining may be collected, preconditioned, sorted, classified, sanitized or otherwise processed according to any process described in this disclosure. Training data may include, without limitation, training examples including inputs and correlated outputs used, received, and/or generated from any version of any system, module, machine-learning model or algorithm, apparatus, and/or method described in this disclosure; such examples may be modified and/or labeled according to user feedback or other processes to indicate desired results, and/or may have actual or measured results from a process being modeled and/or predicted by system, module, machine-learning model or algorithm, apparatus, and/or method as “desired” results to be compared to outputs for training processes as described above.

Redeployment may be performed using any reconfiguring and/or rewriting of reconfigurable and/or rewritable circuit and/or memory elements; alternatively, redeployment may be performed by production of new hardware and/or software components, circuits, instructions, or the like, which may be added to and/or may replace existing hardware and/or software components, circuits, instructions, or the like.

Further referring to FIG. 2, one or more processes or algorithms described above may be performed by at least a dedicated hardware unit 236. A “dedicated hardware unit,” for the purposes of this figure, is a hardware component, circuit, or the like, aside from a principal control circuit and/or processor performing method steps as described in this disclosure, that is specifically designated or selected to perform one or more specific tasks and/or processes described in reference to this figure, such as without limitation preconditioning and/or sanitization of training data and/or training a machine-learning algorithm and/or model. A dedicated hardware unit 236 may include, without limitation, a hardware unit that can perform iterative or massed calculations, such as matrix-based calculations to update or tune parameters, weights, coefficients, and/or biases of machine-learning models and/or neural networks, efficiently using pipelining, parallel processing, or the like; such a hardware unit may be optimized for such processes by, for instance, including dedicated circuitry for matrix and/or signal processing operations that includes, e.g., multiple arithmetic and/or logical circuit units such as multipliers and/or adders that can act simultaneously and/or in parallel or the like. Such dedicated hardware units 236 may include, without limitation, graphical processing units (GPUs), dedicated signal processing modules, FPGA or other reconfigurable hardware that has been configured to instantiate parallel processing units for one or more specific tasks, or the like, A computing device, processor, apparatus, or module may be configured to instruct one or more dedicated hardware units 236 to perform one or more operations described herein, such as evaluation of model and/or algorithm outputs, one-time or iterative updates to parameters, coefficients, weights, and/or biases, and/or any other operations such as vector and/or matrix operations as described in this disclosure.

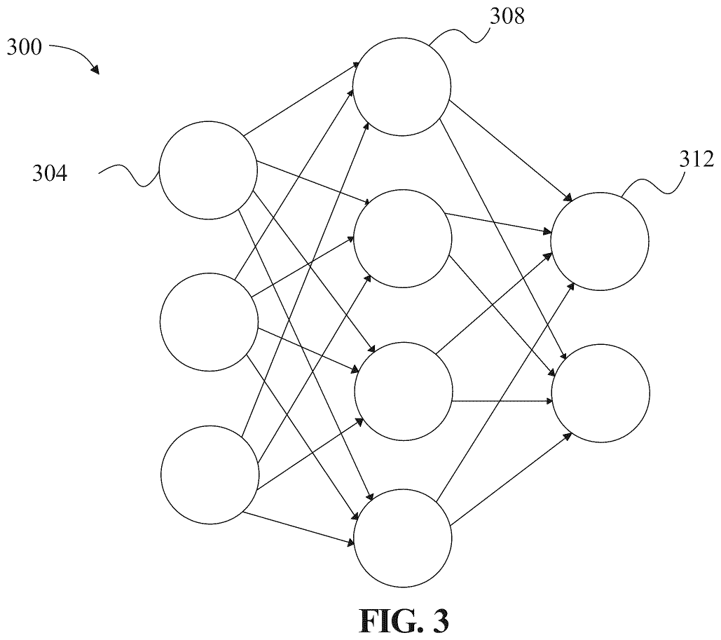

Referring now to FIG. 3, an exemplary embodiment of neural network 300 is illustrated. A neural network 300 also known as an artificial neural network, is a network of “nodes,” or data structures having one or more inputs, one or more outputs, and a function determining outputs based on inputs. Such nodes may be organized in a network, such as without limitation a convolutional neural network, including an input layer of nodes 304, one or more intermediate layers 308, and an output layer of nodes 312. Connections between nodes may be created via the process of “training” the network, in which elements from a training dataset are applied to the input nodes, a suitable training algorithm (such as Levenberg-Marquardt, conjugate gradient, simulated annealing, or other algorithms) is then used to adjust the connections and weights between nodes in adjacent layers of the neural network to produce the desired values at the output nodes. This process is sometimes referred to as deep learning. Connections may run solely from input nodes toward output nodes in a “feed-forward” network, or may feed outputs of one layer back to inputs of the same or a different layer in a “recurrent network.” As a further non-limiting example, a neural network may include a convolutional neural network comprising an input layer of nodes, one or more intermediate layers, and an output layer of nodes. A “convolutional neural network,” as used in this disclosure, is a neural network in which at least one hidden layer is a convolutional layer that convolves inputs to that layer with a subset of inputs known as a “kernel,” along with one or more additional layers such as pooling layers, fully connected layers, and the like.

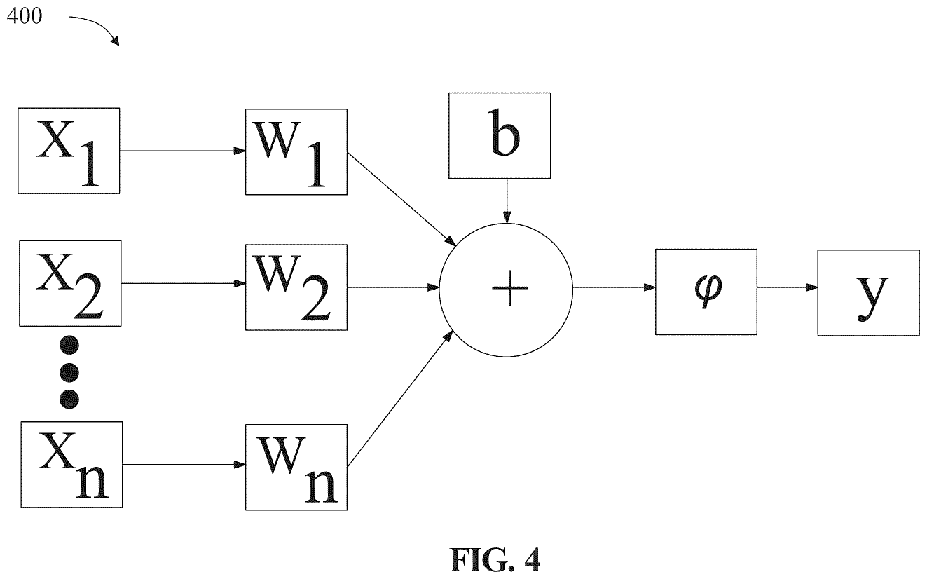

Referring now to FIG. 4, an exemplary embodiment of a node 400 of a neural network is illustrated. A node may include, without limitation a plurality of inputs xᵢ that may receive numerical values from inputs to a neural network containing the node and/or from other nodes. Node may perform one or more activation functions to produce its output given one or more inputs, such as without limitation computing a binary step function comparing an input to a threshold value and outputting either a logic 1 or logic 0 output or something equivalent, a linear activation function whereby an output is directly proportional to the input, and/or a non-linear activation function, wherein the output is not proportional to the input. Non-linear activation functions may include, without limitation, a sigmoid function of the form

$$f ( x ) = \frac{1}{1 - {e}^{- x}}$$

given input x, a tan h (hyperbolic tangent) function, of the form

$$\frac{{e}^{x} - {e}^{- x}}{{e}^{x} + {e}^{- x}} ,$$

a tan h derivative function such as f(x)=tan h²(x), a rectified linear unit function such as f(x)=max (0,x), a “leaky” and/or “parametric” rectified linear unit function such as f(x)=max (ax,x) for some a, an exponential linear units function such as f(x)=

$$f ( x ) = \{ \begin{matrix}x for x \geq 0 \\ α ( {e}^{x} - 1 ) for x < 0\end{matrix}$$

for some value of α (this function may be replaced and/or weighted by its own derivative in some embodiments), a softmax function such as

$$f ( {x}_{i} ) = \frac{{e}^{x}}{{\sum }_{i} {x}_{i}}$$

where the inputs to an instant layer are xᵢ, a swish function such as f(x)=x*sigmoid(x), a Gaussian error linear unit function such as f(x)=a(1+tan h(\sqrt{2/π}(x+bx^{r}))) for some values of a, b, and r, and/or a scaled exponential linear unit function such as

$$f ( x ) = λ \{ \begin{matrix}α ( {e}^{x} - 1 ) for x < 0 \\ x for x \geq 0\end{matrix} .$$

Fundamentally, there is no limit to the nature of functions of inputs xᵢ that may be used as activation functions. As a non-limiting and illustrative example, node may perform a weighted sum of inputs using weights wᵢ that are multiplied by respective inputs xᵢ. Additionally or alternatively, a bias b may be added to the weighted sum of the inputs such that an offset is added to each unit in the neural network layer that is independent of the input to the layer. The weighted sum may then be input into a function φ, which may generate one or more outputs y. Weight wᵢ applied to an input xᵢ may indicate whether the input is “excitatory,” indicating that it has strong influence on the one or more outputs y, for instance by the corresponding weight having a large numerical value, and/or a “inhibitory,” indicating it has a weak effect influence on the one more inputs y, for instance by the corresponding weight having a small numerical value. The values of weights wᵢ, or of other coefficients and/or parameters of an activation function, may be determined by training a neural network using training data, which may be performed using any suitable process as described above. Each weight in a neural network may, without limitation, be updated and/or tuned, based on an error function J, using a backpropagation updating method, such as:

$${w}_{new} = {w}_{old} - α \frac{dJ}{dw}$$

where w_{new} is the updated weight value, w_{old} is the previous weight value, α is a parameter to set the learning rate, and

$$\frac{dJ}{dw}$$

is the partial derivative or with respect to weight w.

Referring now to FIG. 5, in an embodiment, a neural network may comprise a deep neural network (DNN). As used in this disclosure, a “deep neural network” is defined as a neural network with two or more hidden layers. For instance, and without limitation, a DNN 500 may have an input layer 504, a plurality of intermediate layers 508, and an output layer 512. Any number of intermediate layers 508 may be employed, depending on a desired application of a DNN. In a non-limiting example, a neural network may include a convolutional neural network (CNN). A “convolutional neural network,” for the purpose of this disclosure, is a neural network in which at least one hidden layer is a convolutional layer that convolves inputs to that layer with a subset of inputs known as a “kernel,” along with one or more additional layers such as pooling layers, fully connected layers, and the like. In some cases, CNN may include, without limitation, a deep neural network (DNN) extension. Mathematical (or convolution) operations performed in the convolutional layer may include convolution of two or more functions, where the kernel may be applied to input data e.g., through a sliding window approach. In some cases, convolution operations may enable processor 104 to detect local/global patterns, edges, textures, and any other features described herein within input data. Spatial features 140 may be passed through one or more activation functions, such as without limitation, Rectified Linear Unit (ReLU), to introduce non-linearities into the processing steps and/or machine-learning steps as described in this disclosure. Additionally, or alternatively, CNN may also include one or more pooling layers, wherein each pooling layer is configured to reduce the dimensionality of input data while preserving essential features within the input data. In a non-limiting example, CNN may include one or more pooling layer configured to reduce the spatial dimensions of spatial feature maps by applying downsampling, such as max-pooling or average pooling, to small, non-overlapping regions of one or more features.

Still referring to FIG. 1, CNN may further include one or more fully connected layers configured to combine features extracted by the convolutional and pooling layers as described above. In some cases, one or more fully connected layers may allow for higher-level pattern recognition. In a non-limiting example, one or more fully connected layers may connect every neuron (i.e., node) in its input to every neuron in its output, functioning as a traditional feedforward neural network layer. In some cases, one or more fully connected layers may be used at the end of CNN to perform high-level reasoning and produce the final output. Further, each fully connected layer may be followed by one or more dropout layers configured to prevent overfitting, and one or more normalization layers to stabilize the learning process described herein.

Still referring to FIG. 5, machine learning process may include a generative machine learning process. As used in this disclosure, a “generative machine learning process” is a process that automatedly, using a prompt (i.e., input), generates an output consistent with training data; this is in contrast to a non-machine learning software program where outputs are determined in advance by a user and written in a programming language. In some embodiments, generative machine-learning processes may determine patterns and structures from training data and use these patterns and structures to synthesize new data with similar characteristics, as a function of an input. As a non-limiting example, generative machine-learning process may determine patterns and structures from training data of language processing models, or any machine-learning models described in the entirety of this disclosure and may use these patterns to synthesize new data, as a function of an input, such as but not limited to textual or linguistic outputs used in chat functionality.

With continued reference to FIG. 1 generative machine learning processes may synthesize data of different types or domains, including without limitation text, code, images, molecules, audio (e.g., music), video, and robot actions (e.g., electromechanical system actions). Exemplary generative machine learning systems trained on words or word tokens, operant in text domain, include GPT-3, LaMDA, LLAMA, BLOOM, GPT-4, and the like. Exemplary machine learning processes trained on programming language text (i.e., code) include without limitation OpenAI Codex. Exemplary machine learning processes trained on sets of images (for instance with text captions) include Imagen, DALL-E, Midjourney, Adobe Firefly, Stable Diffusion, and the like; image generative machine learning processes, in some cases, may be trained for text-to-image generation and/or neural style transfer. Exemplary generative machine learning processes trained on molecular data include, without limitation, AlphaFold, which may be used for protein structure prediction and drug discovery. Generative machine learning processes trained on audio training data include MusicLM which may be trained on audio waveforms of music correlated with text annotations; music generative machine learning processes, in some cases, may generate new musical samples based on text descriptions. Exemplary generative machine learning processes trained on video include without limitation RunwayML and Make-A-Video by Meta Platforms. Finally, exemplary generative machine learning processes trained using robotic action data include without limitation UniPi from Google Research.

With continued reference to FIG. 1, in some cases a generative machine learning process may include a generative adversarial network (GAN). As used in this disclosure, a “generative adversarial network” is a machine learning process that includes at least two adverse networks configured to synthesize data according to prescribed rules (e.g., rules of a game). In some cases, a generative adversarial network may include a generative and a discriminative network, where the generative network generates candidate data and the discriminative network evaluates the candidate data. An exemplary GAN may be described according to a following game: Each probability space (Ω, μ_{ref}) defines a GAN game. There are two adverse networks: a generator network and a discriminator network. Generator network strategy set is P(Ω), the set of all probability measures μ_{G} on Ω. Discriminator network strategy set is the set of Markov kernels μ_{D}: Ω→P[0,1], where P[0,1] is set of probability measures on [0,1]. GAN game may be a zero-sum game, with objective function:

$$L ( {μ}_{G} , {μ}_{D} ) := {𝔼}_{x ∼ {μ}_{ref} , y ∼ {μ}_{D} ( x )} [ ln y ] + {𝔼}_{x ∼ {μ}_{G} , y ∼ {μ}_{D} ( x )} [ ln ( 1 - y ) ] .$$

Generally, generator network may aim to minimize objective, and discriminator network may aim to maximize the objective. Specifically, generator network seeks to approach μ_{G}≈μ_{ref′}, said another way, generator network produces candidate data that matches its own output distribution as closely as possible to a reference distribution (provided with training data). Discriminator network outputs a value close to 1 when candidate data appears to be from reference (training data) distribution, and to output a value close to 0 when candidate data looks like it came from generator network distribution. Generally speaking, generative network generates candidates while discriminative network evaluates them, with contest operating in terms of data distributions. In some embodiments, generator network may learn to map from a latent space to a data distribution of interest, while discriminator network may distinguish candidates produced by the generator network from a true data distribution (e.g., training data). In some cases, generator network's training objective is to increase an error rate of discriminator network (i.e., “fool” the discriminator network by producing novel candidates that the discriminator thinks are not synthesized but, instead, are part of training data). In some cases, a known dataset may serve as initial training data for discriminator network. Training may involve presenting discriminator network with samples from training dataset until it achieves acceptable accuracy. In some cases, generator network may be trained on whether the generator network succeeds in fooling discriminator network. A generator network may be seeded with randomized input that is sampled from a predefined latent space (e.g. a multivariate normal distribution). Thereafter, candidates synthesized by generator network may be evaluated by discriminator network. Independent backpropagation procedures may be applied to both networks so that generator network may produce better samples, while discriminator network may become more skilled at flagging synthetic samples. When used for image generation, generator network may be a deconvolutional neural network, and discriminator may be a convolutional neural network

Still referring to FIG. 5, a neural network, deep neural network, and/or language processing model may include and/or be included in a large language model (LLM). A “large language model,” as used herein, is a deep learning data structure that can recognize, summarize, translate, predict and/or generate text and other content based on knowledge gained from massive datasets. Large language models may be trained on large sets of data. Training sets may be drawn from diverse sets of data such as, as non-limiting examples, novels, blog posts, articles, emails, unstructured data, electronic records, and the like. In some embodiments, training sets may include a variety of subject matters, such as, as nonlimiting examples, medical report documents, electronic health records, entity documents, business documents, inventory documentation, emails, user communications, advertising documents, newspaper articles, past examples of data input and/or output as described above, including composition data, pecuniary goal data, survey data, data describing goal groups, data describing composition groups, data of and/or describing composition courses, data describing action items, data describing item responses, and/or any data that may be sent or received using a user interface, a chat functionality, or the like as disclosed in this disclosure. In some embodiments, training sets of an LLM may include information from one or more public or private databases. As a non-limiting example, training sets may include databases associated with an entity. In some embodiments, training sets may include portions of documents associated with the electronic records correlated to examples of outputs. In an embodiment, an LLM may include one or more architectures based on capability requirements of an LLM. Exemplary architectures may include, without limitation, GPT (Generative Pretrained Transformer), BERT (Bidirectional Encoder Representations from Transformers), T5 (Text-To-Text Transfer Transformer), and the like. Architecture choice may depend on a needed capability such generative, contextual, or other specific capabilities.

With continued reference to FIG. 5, in some embodiments, an LLM may be generally trained. As used in this disclosure, a “generally trained” LLM is an LLM that is trained on a general training set comprising a variety of subject matters, data sets, and fields. In some embodiments, an LLM may be initially generally trained. Additionally, or alternatively, an LLM may be specifically trained. As used in this disclosure, a “specifically trained” LLM is an LLM that is trained on a specific training set, wherein the specific training set includes data including specific correlations for the LLM to learn. As a non-limiting example, an LLM may be generally trained on a general training set, then specifically trained on a specific training set. In an embodiment, specific training of an LLM may be performed using a supervised machine learning process. In some embodiments, generally training an LLM may be performed using an unsupervised machine learning process. As a non-limiting example, specific training set may include information from a database. As a non-limiting example, specific training set may include text related to the users such as user specific data for electronic records correlated to examples of outputs. In an embodiment, training one or more machine learning models may include setting the parameters of the one or more models (weights and biases) either randomly or using a pretrained model. Generally training one or more machine learning models on a large corpus of text data can provide a starting point for fine-tuning on a specific task. A model such as an LLM may learn by adjusting its parameters during the training process to minimize a defined loss function, which measures the difference between predicted outputs and ground truth. Once a model has been generally trained, the model may then be specifically trained to fine-tune the pretrained model on task-specific data to adapt it to the target task. Fine-tuning may involve training a model with task-specific training data, adjusting the model's weights to optimize performance for the particular task. In some cases, this may include optimizing the model's performance by fine-tuning hyperparameters such as learning rate, batch size, and regularization. Hyperparameter tuning may help in achieving the best performance and convergence during training. In an embodiment, fine-tuning a pretrained model such as an LLM may include fine-tuning the pretrained model using Low-Rank Adaptation (LoRA). As used in this disclosure, “Low-Rank Adaptation” is a training technique for large language models that modifies a subset of parameters in the model. Low-Rank Adaptation may be configured to make the training process more computationally efficient by avoiding a need to train an entire model from scratch. In an exemplary embodiment, a subset of parameters that are updated may include parameters that are associated with a specific task or domain.

With continued reference to FIG. 5, in some embodiments an LLM may include and/or be produced using Generative Pretrained Transformer (GPT), GPT-2, GPT-3, GPT-4, and the like. GPT, GPT-2, GPT-3, GPT-3.5, and GPT-4 are products of Open AI Inc., of San Francisco, CA. An LLM may include a text prediction based algorithm configured to receive an article and apply a probability distribution to the words already typed in a sentence to work out the most likely word to come next in augmented articles. For example, if some words that have already been typed are “Nice to meet,” then it may be highly likely that the word “you” will come next. An LLM may output such predictions by ranking words by likelihood or a prompt parameter. For the example given above, an LLM may score “you” as the most likely, “your” as the next most likely, “his” or “her” next, and the like. An LLM may include an encoder component and a decoder component.

Still referring to FIG. 5, an LLM may include a transformer architecture. In some embodiments, encoder component of an LLM may include transformer architecture. A “transformer architecture,” for the purposes of this disclosure is a neural network architecture that uses self-attention and positional encoding. Transformer architecture may be designed to process sequential input data, such as natural language, with applications towards tasks such as translation and text summarization. Transformer architecture may process the entire input all at once. “Positional encoding,” for the purposes of this disclosure, refers to a data processing technique that encodes the location or position of an entity in a sequence. In some embodiments, each position in the sequence may be assigned a unique representation. In some embodiments, positional encoding may include mapping each position in the sequence to a position vector. In some embodiments, trigonometric functions, such as sine and cosine, may be used to determine the values in the position vector. In some embodiments, position vectors for a plurality of positions in a sequence may be assembled into a position matrix, wherein each row of position matrix may represent a position in the sequence.

With continued reference to FIG. 5, an LLM and/or transformer architecture may include an attention mechanism. An “attention mechanism,” as used herein, is a part of a neural architecture that enables a system to dynamically quantify the relevant features of the input data. In the case of natural language processing, input data may be a sequence of textual elements. It may be applied directly to the raw input or to its higher-level representation.

With continued reference to FIG. 5, attention mechanism may represent an improvement over a limitation of an encoder-decoder model. An encoder-decider model encodes an input sequence to one fixed length vector from which the output is decoded at each time step. This issue may be seen as a problem when decoding long sequences because it may make it difficult for the neural network to cope with long sentences, such as those that are longer than the sentences in the training corpus. Applying an attention mechanism, an LLM may predict the next word by searching for a set of positions in a source sentence where the most relevant information is concentrated. An LLM may then predict the next word based on context vectors associated with these source positions and all the previously generated target words, such as textual data of a dictionary correlated to a prompt in a training data set. A “context vector,” as used herein, are fixed-length vector representations useful for document retrieval and word sense disambiguation.

Still referring to FIG. 5, attention mechanism may include, without limitation, generalized attention self-attention, multi-head attention, additive attention, global attention, and the like. In generalized attention, when a sequence of words or an image is fed to an LLM, it may verify each element of the input sequence and compare it against the output sequence. Each iteration may involve the mechanism's encoder capturing the input sequence and comparing it with each element of the decoder's sequence. From the comparison scores, the mechanism may then select the words or parts of the image that it needs to pay attention to. In self-attention, an LLM may pick up particular parts at different positions in the input sequence and over time compute an initial composition of the output sequence. In multi-head attention, an LLM may include a transformer model of an attention mechanism. Attention mechanisms, as described above, may provide context for any position in the input sequence. For example, if the input data is a natural language sentence, the transformer does not have to process one word at a time. In multi-head attention, computations by an LLM may be repeated over several iterations, each computation may form parallel layers known as attention heads. Each separate head may independently pass the input sequence and corresponding output sequence element through a separate head. A final attention score may be produced by combining attention scores at each head so that every nuance of the input sequence is taken into consideration. In additive attention (Bahdanau attention mechanism), an LLM may make use of attention alignment scores based on a number of factors. Alignment scores may be calculated at different points in a neural network, and/or at different stages represented by discrete neural networks. Source or input sequence words are correlated with target or output sequence words but not to an exact degree. This correlation may take into account all hidden states and the final alignment score is the summation of the matrix of alignment scores. In global attention (Luong mechanism), in situations where neural machine translations are required, an LLM may either attend to all source words or predict the target sentence, thereby attending to a smaller subset of words.

With continued reference to FIG. 5, multi-headed attention in encoder may apply a specific attention mechanism called self-attention. Self-attention allows models such as an LLM or components thereof to associate each word in the input, to other words. As a non-limiting example, an LLM may learn to associate the word “you,” with “how” and “are.” It's also possible that an LLM learns that words structured in this pattern are typically a question and to respond appropriately. In some embodiments, to achieve self-attention, input may be fed into three distinct fully connected neural network layers to create query, key, and value vectors. A query vector may include an entity's learned representation for comparison to determine attention score. A key vector may include an entity's learned representation for determining the entity's relevance and attention weight. A value vector may include data used to generate output representations. Query, key, and value vectors may be fed through a linear layer; then, the query and key vectors may be multiplied using dot product matrix multiplication in order to produce a score matrix. The score matrix may determine the amount of focus for a word should be put on other words (thus, each word may be a score that corresponds to other words in the time-step). The values in score matrix may be scaled down. As a non-limiting example, score matrix may be divided by the square root of the dimension of the query and key vectors. In some embodiments, the softmax of the scaled scores in score matrix may be taken. The output of this softmax function may be called the attention weights. Attention weights may be multiplied by your value vector to obtain an output vector. The output vector may then be fed through a final linear layer.

Still referencing FIG. 5, in order to use self-attention in a multi-headed attention computation, query, key, and value may be split into N vectors before applying self-attention. Each self-attention process may be called a “head.” Each head may produce an output vector and each output vector from each head may be concatenated into a single vector. This single vector may then be fed through the final linear layer discussed above. In theory, each head can learn something different from the input, therefore giving the encoder model more representation power.

With continued reference to FIG. 5, encoder of transformer may include a residual connection. Residual connection may include adding the output from multi-headed attention to the positional input embedding. In some embodiments, the output from residual connection may go through a layer normalization. In some embodiments, the normalized residual output may be projected through a pointwise feed-forward network for further processing. The pointwise feed-forward network may include a couple of linear layers with a ReLU activation in between. The output may then be added to the input of the pointwise feed-forward network and further normalized.

Continuing to refer to FIG. 5, transformer architecture may include a decoder. Decoder may a multi-headed attention layer, a pointwise feed-forward layer, one or more residual connections, and layer normalization (particularly after each sub-layer), as discussed in more detail above. In some embodiments, decoder may include two multi-headed attention layers. In some embodiments, decoder may be autoregressive. For the purposes of this disclosure, “autoregressive” means that the decoder takes in a list of previous outputs as inputs along with encoder outputs containing attention information from the input.

With further reference to FIG. 5, in some embodiments, input to decoder may go through an embedding layer and positional encoding layer in order to obtain positional embeddings. Decoder may include a first multi-headed attention layer, wherein the first multi-headed attention layer may receive positional embeddings.

With continued reference to FIG. 5, first multi-headed attention layer may be configured to not condition to future tokens. As a non-limiting example, when computing attention scores on the word “am,” decoder should not have access to the word “fine” in “I am fine,” because that word is a future word that was generated after. The word “am” should only have access to itself and the words before it. In some embodiments, this may be accomplished by implementing a look-ahead mask. Look ahead mask is a matrix of the same dimensions as the scaled attention score matrix that is filled with “0s” and negative infinities. For example, the top right triangle portion of look-ahead mask may be filled with negative infinities. Look-ahead mask may be added to scaled attention score matrix to obtain a masked score matrix. Masked score matrix may include scaled attention scores in the lower-left triangle of the matrix and negative infinities in the upper-right triangle of the matrix. Then, when the softmax of this matrix is taken, the negative infinities will be zeroed out; this leaves zero attention scores for “future tokens.”

Still referring to FIG. 5, second multi-headed attention layer may use encoder outputs as queries and keys and the outputs from the first multi-headed attention layer as values. This process matches the encoder's input to the decoder's input, allowing the decoder to decide which encoder input is relevant to put a focus on. The output from second multi-headed attention layer may be fed through a pointwise feedforward layer for further processing.

With continued reference to FIG. 5, the output of the pointwise feedforward layer may be fed through a final linear layer. This final linear layer may act as a classifier. This classifier may be as big as the number of classes that you have. For example, if you have 10,000 classes for 10,000 words, the output of that classifier will be of size 10,000. The output of this classifier may be fed into a softmax layer which may serve to produce probability scores between zero and one. The index may be taken of the highest probability score in order to determine a predicted word.

Still referring to FIG. 5, decoder may take this output and add it to the decoder inputs. Decoder may continue decoding until a token is predicted. Decoder may stop decoding once it predicts an end token.

Continuing to refer to FIG. 5, in some embodiment, decoder may be stacked N layers high, with each layer taking in inputs from the encoder and layers before it. Stacking layers may allow an LLM to learn to extract and focus on different combinations of attention from its attention heads.

With continued reference to FIG. 5, an LLM may receive an input. Input may include a string of one or more characters. Inputs may additionally include unstructured data. For example, input may include one or more words, a sentence, a paragraph, a thought, a query, and the like. A “query” for the purposes of the disclosure is a string of characters that poses a question. In some embodiments, input may be received from a user device. User device may be any computing device that is used by a user. As non-limiting examples, user device may include desktops, laptops, smartphones, tablets, and the like. In some embodiments, input may include any set of data used in processes and/or components as described in this disclosure.

With continued reference to FIG. 5, an LLM may generate at least one annotation as an output. At least one annotation may be any annotation as described herein. In some embodiments, an LLM may include multiple sets of transformer architecture as described above. Output may include a textual output. A “textual output,” for the purposes of this disclosure is an output comprising a string of one or more characters. Textual output may include, for example, a plurality of annotations for unstructured data. In some embodiments, textual output may include a phrase or sentence identifying the status of a user query. In some embodiments, textual output may include a sentence or plurality of sentences describing a response to a user query. As a non-limiting example, this may include restrictions, timing, advice, dangers, benefits, and the like.

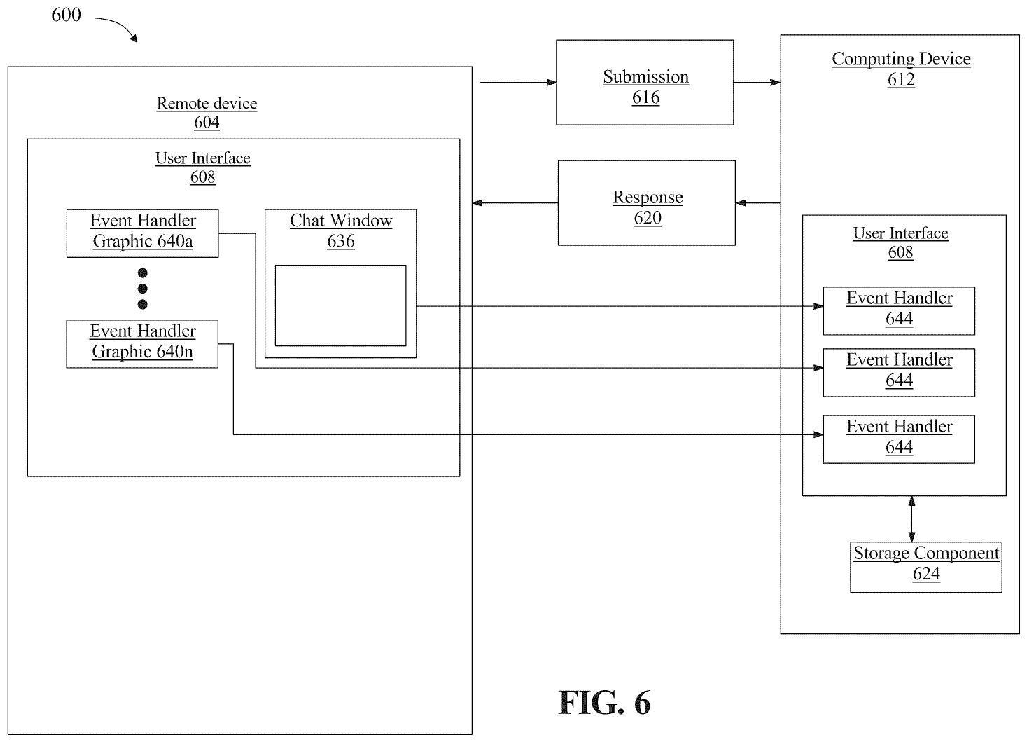

Referring now to FIG. 6, a user interface system 600 is schematically illustrated. User interface system 600 may configure a computing device 612 to configure a remote device 604 to perform display, input, and output functions, without limitation of a user interface. According to some embodiments, a user interface 608 may be communicative with a computing device 612, such as computing device as described above, that is configured to operate a chatbot. In some cases, user interface 608 may be local to computing device 612. Alternatively or additionally, in some cases, user interface 608 may remote to computing device 612 and communicative with the computing device 612, by way of one or more networks, such as without limitation the internet. Alternatively or additionally, user interface 608 may communicate with user device using telephonic devices and networks, such as without limitation fax machines, short message service (SMS), or multimedia message service (MMS). Commonly, user interface 608 communicates with computing device 612 using text-based communication, for example without limitation using a character encoding protocol, such as American Standard for Information Interchange (ASCII). Textual communication may be made between two or more users operating user devices, each of which may be configured by computing device to implement user interface. Two or more users may communicate with one another via user interface instances; alternatively or additionally, user interface 608 may conversationally interface using a chatbot, by way of at least a submission 616, from the user interface 608 to the chatbot, and a response 620, from the chatbot to the user interface 608. In many cases, one or both of submission 616 and response 620 are text-based communication. Alternatively or additionally, in some cases, one or both of submission 616 and response 620 are audio-based communication.

Continuing in reference to FIG. 6, a submission 616 once received by computing device 612 operating a chatbot, may be processed by circuitry and/or a processor, for instance and without limitation as described above. In some embodiments, processor processes a submission 6112 using one or more of keyword recognition, pattern matching, and natural language processing. In some embodiments, processor employs real-time learning with evolutionary algorithms. In some cases, processor may retrieve a pre-prepared response from at least a storage component 624, based upon submission 616. Alternatively or additionally, in some embodiments, processor communicates a response 620 without first receiving a submission 616, thereby initiating conversation. Alternatively or additionally, processor may input user-submitted or other text as an input and may output a textual response using one or more generative artificial intelligence processes and/or components, such as without limitation an LLM or other generative model as described above. In some cases, processor communicates an inquiry to user interface 608; and the processor is configured to process an answer to the inquiry in a following submission 616 from the user interface 608. In some cases, an answer to an inquiry present within a submission 616 from a user device may be used by computing device 104 as an input to another function; inputs may include without limitation, composition data, pecuniary goal data, data suitable for use as survey data, or the like. Inputs generated by a chatbot may be input, without limitation, to any process, module, component, or other element described in this disclosure that can accept an input.

Still referring to FIG. 6, apparatus may, for instance, use a client-side program to configure a user device to display data and/or to perform event handling of user inputs; such display may be implemented, without limitation, as a graphical user interface. For instance, and without limitation, apparatus may display any output of any authentication process, any output of computation of predicted message, any output of any process used in computation of predicted message, any output of any authorization process, and/or any output of processes used to perform authorization. Apparatus and/or circuitry may configure a user device to display one or more event handler graphics 640a-n. As used in this disclosure, an “event handler graphic 640a-n” is a graphical element with which a user of remote device may interact to enter data, for instance and without limitation for a search query or the like as described in further detail below. An event handler graphic 640a-n may include, without limitation, a button, a link, a checkbox, a text entry box and/or window, a drop-down list, a slider, or any other event handler graphic 640a-n that may occur to a person skilled in the art upon reviewing the entirety of this disclosure. An “event handler 644,” as used in this disclosure, is a module, data structure, function, and/or routine that performs an action on remote device in response to a user interaction with event handler graphic 640a-n. For instance, and without limitation, an event handler 644 may record data corresponding to user selections of previously populated fields such as drop-down lists and/or text auto-complete and/or default entries, data corresponding to user selections of checkboxes, radio buttons, or the like, potentially along with automatically entered data triggered by such selections, user entry of textual data using a keyboard, touchscreen, speech-to-text program, or the like. Event handler 644 may generate prompts for further information, may compare data to validation rules such as requirements that the data in question be entered within certain numerical ranges, and/or may modify data and/or generate warnings to a user in response to such requirements. Event handler 644 may convert data into expected and/or desired formats, for instance such as date formats, currency entry formats, name formats, or the like. Event handler 644 may transmit data from remote device to apparatus and/or circuitry.

In an embodiment, and further referring to FIG. 1, event handler 644 may include a cross-session state variable. As used herein, a “cross-session state variable” is a variable recording data entered on remote device during a previous session. Such data may include, for instance, previously entered text, previous selections of one or more elements as described above, or the like. For instance, cross-session state variable data may represent a search a user entered in a past session. Cross-session state variable may be saved using any suitable combination of client-side data storage on remote device and server-side data storage on apparatus and/or circuitry; for instance, data may be saved wholly or in part as a “cookie” which may include data or an identification of remote device to prompt provision of cross-session state variable by apparatus and/or circuitry, which may store the data on apparatus and/or circuitry. Alternatively, or additionally, apparatus and/or circuitry may use login credentials, device identifier, and/or device fingerprint data to retrieve cross-session state variable, which apparatus and/or circuitry may transmit to remote device. Cross-session state variable may include at least a prior session datum. A “prior session datum” may include any element of data that may be stored in a cross-session state variable. Event handler graphic 640a-n may be further configured to display the at least a prior session datum, for instance and without limitation auto-populating user query data from previous sessions.

With continued reference to FIG. 6, in one or more embodiments, users may utilize instances of user interface system 600 to exchange text messages with each other. User interface 608 may include functionality to configure each or any remote device to display a chat window. A chat window may include a window or field that displays text generated by one or more users and/or chatbot outputs, and/or a window or field for entry of textual data by a user; windows and/or fields for display and entry may be separate. An event handler graphic 640a-n and/or event handler 644 may transmit textual entries and/or display such entries, for instance and without limitation when a user “posts” such entries to make them visible to a chatbot and/or another user.

Still referring to FIG. 6, user interface 608 may include one or more data entry event handler graphics 640a-n, which may be used to receive user entries such as composition data, survey data, pecuniary goals, acceptance and/or rejection of one or more outputs and/or advisory submissions from advisors, or the like. Event handler graphics 640a-n may include, without limitation, lists such as dropdown lists or static checklists showing elements to be accepted, rejected, and/or selected by a user. Event handler graphics 640a-n may include text boxes or other textual input fields where a user may enter text to be processed using methods and/or method steps as described in this disclosure. For instance, and without limitation, event handler graphics 640a-n may include survey questions and fields for provision of answers, such as text boxes for freely written answers, radio buttons, checkboxes, and/or drop-down list entries; such entries indicating selections between proffered choices may be generated using generative AI and/or LLM outputs generating lists of possibilities based on user data such as any previous user entries as described in this disclosure, including textual entries made while communicating with a chatbot, another user, and adviser, or the like, any entries or stored data representing composition data and/or other user data, or the like. AI and/or LLM may be trained on a generalized corpus of textual and/or image data, and/or may be trained on chat data, composition data, and/or survey entries, as well as user feedback therefor, from previous iterations of methods and/or method steps as described in this disclosure.

Further referring to FIG. 6, computing device and/or chatbot elements may log, scrape, or otherwise record textual communications such as chatbot communications, chats with users, chats with advisors, or the like. Computing device may periodically or in response to inputs and/or other triggers automatically run or rerun any step described above. A machine-learning model, neural network, generative machine-learning model, and/or LLM may generate, regenerate, and/or add to composition data, user data, pecuniary goals, or the like and use such updated inputs to processes and/or process steps as described in this disclosure. In an embodiment, reprocessing of steps and/or methods described in this disclosure may be triggered by a request by an advisor and/or user to cause such reprocessing, for instance and without limitation by selection of an event handler graphic 640a-n indicating such purpose, selection of which may initiate execution of an event handler 644 that in turn triggers such reprocessing. Alternatively or additionally, a machine-learning model and/or neural network may compare textual or other inputs by users and/or advisors, or encodings thereof generated by an encoder as described above to, e.g., vectors, embeddings, or the like matching user or advisor-entered scenarios in which reprocessing is desirable; such scenarios may be encoded to, e.g. vectors and/or embeddings and stored for later comparison.

Still referring to FIG. 6, a generative AI model, generative neural network, and/or LLM may be configured to generate explanations of action items, composition courses, item responses, and/or other outputs. Explanations may include, without limitation, narrative and/or textual outputs, images and/or graphics illustrating outputs, and/or chat conversations with users. For instance, and without limitation, users may be able to enter questions regarding outputs in a chat window 636, and a chatbot may use an LLM and/or generative model and/or neural network to generate answers to the questions. Computing device may be configured to generate a series of steps relating to an action item, strategy, or the like.

With continued reference to FIG. 6, computing device may be configured to display any output, including without limitation action strategy, action, advisory data and/or outputs, courses, or the like to an advisor; display may be performed, without limitation, using a user interfacing system 600, or any component thereof, as described in this disclosure. Computing device may configure a remote device operated by an advisor to provide feedback provision options such as those described above for other users; feedback may be received, processed, and/or used to repeat one or more process steps as described above for user feedback.

As a non-limiting example, and still referring to FIG. 6, apparatus may be configured to modify and/or generate event handler graphics, with corresponding event handlers, based on output of LLM and/or other machine-learning and/or AI model and/or process as described above. For instance, and without limitation, a conversational AI layer may use natural language processing, including without limitation via an LLM or one or more components thereof as described above, for intent recognition and entity extraction from user responses to chatbot communications and/or entries at event handler graphics or form elements. In a non-limiting embodiment, an encoder may map user entries directly to embeddings and/or numerical outputs and/or may map detected sentiments and/or descriptors therefor to embeddings and/or numerical outputs; encoder may be trained to generate embeddings and/or numerical outputs corresponding to particular event handler graphic and event handler combinations that may be stored and retrieved using a hashtable, lookup table, database, or the like, which apparatus may configure a user device to display, for instance and without limitation as a form or component of a form. In some embodiments, apparatus may replace traditional static data-entry forms with an AI-driven conversational interface using above-described approaches; Instead of navigating multiple form screens, users may be able to interact with a virtual advisor, implemented using chatbot and event handler generation processes as described above that sequentially collects the same required data through natural dialogue and/or a combination of natural dialog and interactions with event handlers. In some embodiments, apparatus, user interface, and/or an AI module such as without limitation an LLM may generate contextual explanations for each input field and/or chatbot output and/or input, for instance by inputting a prompt to an LLM requesting an explanation for each input field and/or output/input; such explanations may be displayed in a separate field from form and/or chatbot element and/or may be provided via chatbot or text displayed by user interface. Chatbot and/or user interface may dynamically adapt questions, input fields, event handlers, event handler graphics, and/or other elements based on prior responses received and/or generated by any component of user interface.

In some embodiments, and continuing to refer to FIG. 6, user interface and/or apparatus may maintain state management, for instance and without limitation using a cross-session and/or persistent session state data structure, so the user can leave one form, complete another, and return without losing context. In some embodiments, above-described processes may replace traditional static data-entry forms with an AI-driven conversational interface. Instead of navigating multiple form screens, users may be able to interact with a virtual advisor that sequentially collects the same required data through natural dialogue. AI may provides contextual explanations for each input field and dynamically adapt questions based on prior responses. Conventional web forms are rigid and linear, often causing user fatigue, incomplete data submission, and high abandonment rates. They also limit the ability to clarify ambiguous entries without manual support. AI-driven input processes as described above may enable dynamic question sequencing, contextual guidance, and natural-language understanding to interpret user responses; this may allow users to skip or revisit sections freely without losing data continuity. Architecture as described above may support both linear and non-linear workflows, improving engagement, completion accuracy, and data integrity.

In some embodiments, and still referring to FIG. 6, apparatus may be configured to dynamically generate or modify user input forms during disclosed processes, for instance and without limitation using processes, components, and/or configuration as described above. As a user progresses through a standard data-collection sequence, AI elements, chatbot elements, or the like may detect missing or relevant context not captured by predefined questions; apparatus and/or user interface may then create new form fields or mini-forms within a given step to gather additional information, which may, in a non-limiting example, expand a user profile beyond its previous and/or original scope. Traditional form-based systems rely on static, predefined fields and cannot adapt to the unique or unforeseen aspects of an individual's financial or strategic context. This limits personalization, leads to incomplete data sets, and often requires manual follow-up by human advisors. Dynamic form generation may resolve this issue by allowing for real-time customization of a user intake or other process. Using contextual analysis of prior answers, AI or other elements disclosed in this disclosure may identify missing data relationships and/or prompt for additional details. This may result in a richer user profile, which may improve accuracy of processes disclosed herein, including without limitation recommendations and/or reports. Embodiments may include both AI-led and hybrid workflows where users can generate a comprehensive report for independent review or share it with a human advisor.

In some embodiments, and still referring to FIG. 6, apparatus and/or user interface may be configured to generate and/or provide a unified dashboard consolidates all user data, summaries, and AI-generated insights into an interactive, continuously updating interface. Dashboard may visually represent progress, benefits, and/or next steps while enabling users to convert insights into actionable items or learning opportunities. Static dashboards used in conventional user interfaces lack interactivity and fail to encourage repeat engagement or translate analytical insights into actions. Embodiments presented herein may resolve this problem by transforming static reports into an adaptive visual interface, the system improves comprehension and engagement. Summarized insights may be converted into action items, for instance and without limitation using processes as described above, which may a continuous loop of analysis, recommendation, and user action. This design may foster ongoing participation and provide measurable reinforcement of value. Event handler graphics and/or display elements may include modular widgets for graphs, progress tracking, and goal summaries, or the like. In some embodiments, user interface may include user-specific elements, which may persist from one session to another; user interface elements may be linked to a user account in a stored data structure, which may generate a personalized user interface based on the stored link. In some embodiments, a first data structure may store user-related user interface links while a second data structure may store advisor-related user interface links; there may be multiple advisor-related and/or user-related data structures, representing one such structure per user and/or advisor, respectively. All such data structures may update continually when new and/or modified user elements are generated and/or selected as described above.

In some embodiments, and with continued reference to FIG. 6, a persistent AI assistant may be embedded across the entire platform, system, and/or apparatus, allowing users to ask questions, retrieve data, and receive contextual guidance without leaving their workflow; AI models, chatbot, or the like may have state and/or history of communication stored in cross-session state variables, which may be indexed to specific user and/or stored in a database for retrieval upon identification of the user in an active session. Chatbot and/or other models may be accessed globally or triggered contextually within forms, dashboards, and learning materials. In addition to standard chat functionality, the AI, chatbot, or the like may connect directly to internal data APIs and content databases, enabling retrieval of targeted information across products. Chatbot and/or may also be configured to integrate with internal or third-party LLMs for enhanced reasoning, contextual understanding, and domain-specific dialogue generation. This broad integration may enable the assistant to function as a continuously available, intelligent companion that adapts to both user needs and platform context. Conventional help systems isolate support from user workflows, requiring users to exit their current task and search for assistance manually. A persistent AI assistant may resolve this problem by integrating conversational support directly into the application's core user experience. It provides in-context explanations, guidance, and data retrieval on demand, enhancing comprehension and maintaining user flow.

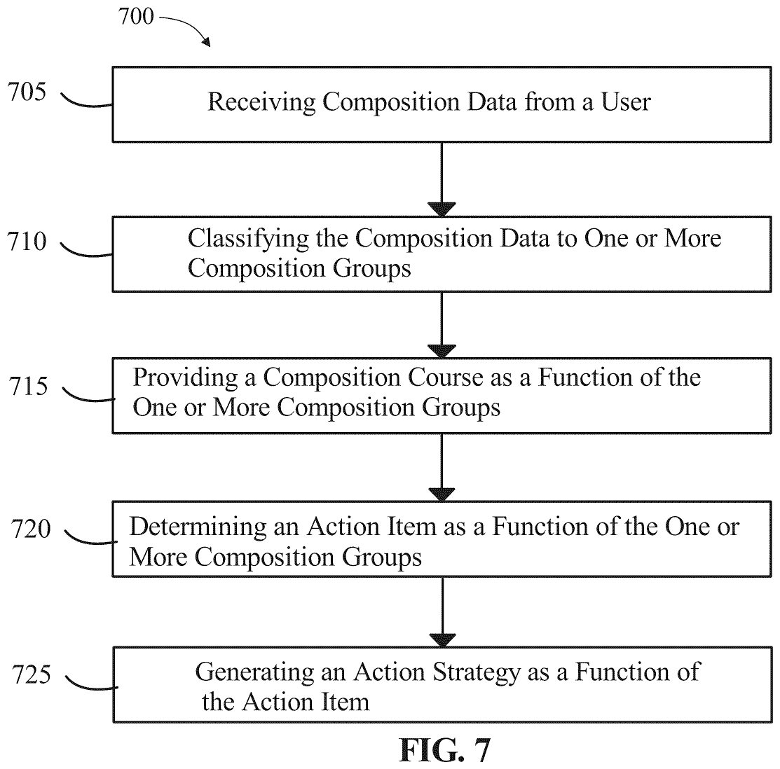

Referring now to FIG. 7, a flow diagram of a method 700 of generating an action strategy. Method 700 includes a step 705 of receiving, using at least a processor, composition data from a user. In some embodiments, the composition data may include document data. Method 700 includes a step 710 of classifying the composition data, using the at least a processor, to one or more composition groups. In some embodiments, the composition data may be classified to the one or more composition groups using a group classifier, wherein the group classifier may be configured to receive group training data, wherein the group training data may include the composition data, and correlate the group training data to the one or more composition groups. In some embodiments, method 700 includes a step 715 of providing, using the at least a processor, a composition course as a function of the one or more composition groups. In some embodiments, the composition course may include an assessment Method 700 includes a step 720 of determining, using the at least a processor, an action item as a function of the one or more composition groups. In some embodiments, determining the action item may include receiving an item response from the user. In some embodiments, the item response may include a course response. In some embodiments, determining the action item may include determining an item status of the action item as a function of the item response using a status machine-learning model. In some embodiments, the item status may include a course status, wherein the course status may include a completion status of the composition course. In some embodiments, determining the action item may further include generating, using an action machine-learning model, a first action item, wherein the action machine-learning model may be configured to correlate action training data to the action item, receiving, using the at least a processor, the course response from the user for the first action item, determining, using the status machine-learning model, the completion status of the composition course, and identifying, using the action machine-learning model, a second action item as a function of the completion status of the composition course. Method 700 includes a step 725 of generating, using the at least a processor, an action strategy as a function of the action item. In some embodiments, the at least a processor may further configured to generate a report using a graph machine-learning model, wherein the report may include a graphically represented item of the composition data and generating the report using the graph machine-learning model may further include receiving a graph training data, wherein the graph training data may include the composition data, and creating the report as a function of the graph training data set, where in the report may include the graphically represented item of the composition data. This may be implemented as disclosed with reference to FIGS. 1-4.

It is to be noted that any one or more of the aspects and embodiments described herein may be conveniently implemented using one or more machines (e.g., one or more computing devices that are utilized as a user computing device for an electronic document, one or more server devices, such as a document server, etc.) programmed according to the teachings of the present specification, as will be apparent to those of ordinary skill in the computer art. Appropriate software coding can readily be prepared by skilled programmers based on the teachings of the present disclosure, as will be apparent to those of ordinary skill in the software art. Aspects and implementations discussed above employing software and/or software modules may also include appropriate hardware for assisting in the implementation of the machine executable instructions of the software and/or software module.

Such software may be a computer program product that employs a machine-readable storage medium. A machine-readable storage medium may be any medium that is capable of storing and/or encoding a sequence of instructions for execution by a machine (e.g., a computing device) and that causes the machine to perform any one of the methodologies and/or embodiments described herein. Examples of a machine-readable storage medium include, but are not limited to, a magnetic disk, an optical disc (e.g., CD, CD-R, DVD, DVD-R, etc.), a magneto-optical disk, a read-only memory “ROM” device, a random access memory “RAM” device, a magnetic card, an optical card, a solid-state memory device, an EPROM, an EEPROM, and any combinations thereof. A machine-readable medium, as used herein, is intended to include a single medium as well as a collection of physically separate media, such as, for example, a collection of compact discs or one or more hard disk drives in combination with a computer memory. As used herein, a machine-readable storage medium does not include transitory forms of signal transmission.

Such software may also include information (e.g., data) carried as a data signal on a data carrier, such as a carrier wave. For example, machine-executable information may be included as a data-carrying signal embodied in a data carrier in which the signal encodes a sequence of instruction, or portion thereof, for execution by a machine (e.g., a computing device) and any related information (e.g., data structures and data) that causes the machine to perform any one of the methodologies and/or embodiments described herein.

Examples of a computing device include, but are not limited to, an electronic book reading device, a computer workstation, a terminal computer, a server computer, a handheld device (e.g., a tablet computer, a smartphone, etc.), a web appliance, a network router, a network switch, a network bridge, any machine capable of executing a sequence of instructions that specify an action to be taken by that machine, and any combinations thereof. In one example, a computing device may include and/or be included in a kiosk.

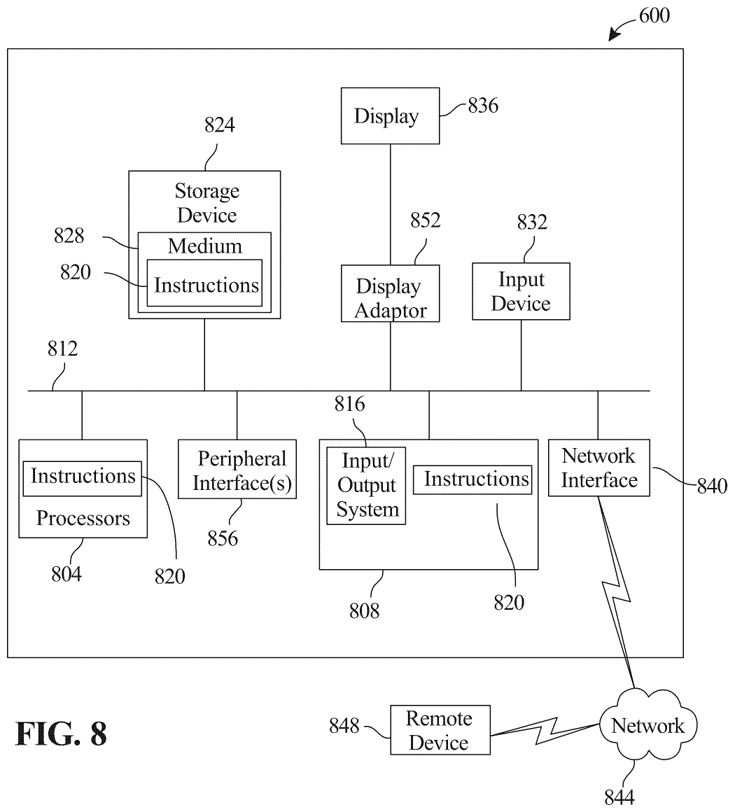

FIG. 8 shows a diagrammatic representation of one embodiment of a computing device in the exemplary form of a computer system 800 within which a set of instructions for causing a control system to perform any one or more of the aspects and/or methodologies of the present disclosure may be executed. It is also contemplated that multiple computing devices may be utilized to implement a specially configured set of instructions for causing one or more of the devices to perform any one or more of the aspects and/or methodologies of the present disclosure. Computer system 800 includes a processor 804 and a memory 808 that communicate with each other, and with other components, via a bus 812. Bus 812 may include any of several types of bus structures including, but not limited to, a memory bus, a memory controller, a peripheral bus, a local bus, and any combinations thereof, using any of a variety of bus architectures.

Processor 804 may include any suitable processor, such as without limitation a processor incorporating logical circuitry for performing arithmetic and logical operations, such as an arithmetic and logic unit (ALU), which may be regulated with a state machine and directed by operational inputs from memory and/or sensors; processor 804 may be organized according to Von Neumann and/or Harvard architecture as a non-limiting example. Processor 804 may include, incorporate, and/or be incorporated in, without limitation, a microcontroller, microprocessor, digital signal processor (DSP), Field Programmable Gate Array (FPGA), Complex Programmable Logic Device (CPLD), Graphical Processing Unit (GPU), general purpose GPU, Tensor Processing Unit (TPU), analog or mixed signal processor, Trusted Platform Module (TPM), a floating point unit (FPU), system on module (SOM), and/or system on a chip (SoC). Each processor and/or processor core may perform a state transition, instruction, and/or instruction step during a period of a “clock,” or a regular oscillator that generates periodic output waveform, such as a square wave, having a regular period; different processors and/or cores may have distinct clocks. A processor may operate as and/or include a processing unit that performs instruction inputs, arithmetic operations, logical operations, memory retrieval operations, memory allocation operations, and/or input and output operations; a control circuit or module within a processor may determine which of the above-described functions a processor and/or unit within a processor will perform on a given clock cycle. A processor may include a plurality of processing units or “cores,” each of which performs the above-described actions; multiple cores may work on disparate instruction sets and/or may work in parallel. A single core may also include multiple arithmetic, logic, or other units that can work in parallel with each other. Parallel computing between and/or within processors and/or cores may include multithreading processes and/or protocols such as without limitation Tomasulo's algorithm. As used in this disclosure, “a processor,” and/or “configuring a processor,” is equivalent for the purposes of this disclosure to at least a processor, a plurality of processors, and/or a plurality of processor cores, and/or programming at least a processor, a plurality of processors, and/or a plurality of processor cores, which may be configured to operate on instructions in parallel and/or sequentially according to multithreading algorithms, parallel computing, load and/or task balancing, and/or virtualization, for instance and without limitation as described below.

Memory 808 may include various components (e.g., machine-readable media) including, but not limited to, a random-access memory component, a read only component, and any combinations thereof. In one example, a basic input/output system 816 (BIOS), including basic routines that help to transfer information between elements within computer system 800, such as during start-up, may be stored in memory 808. Memory 808 may also include (e.g., stored on one or more machine-readable media) instructions (e.g., software) 820 embodying any one or more of the aspects and/or methodologies of the present disclosure. In another example, memory 808 may further include any number of program modules including, but not limited to, an operating system, one or more application programs, other program modules, program data, and any combinations thereof. Memory 808 may include a primary memory and a secondary memory. “Primary memory,” which may be implemented, without limitation as “random access memory” (RAM), is memory used for temporarily storing data for active use by a processor. In one or more embodiments, during use of the computing device, instructions and/or information may be transmitted to primary memory wherein information may be processed. In one or more embodiments, information may only be populated within primary memory while a particular software is running. In one or more embodiments, information within primary memory is wiped and/or removed after the computing device has been turned off and/or use of a software has been terminated. In one or more embodiments, primary memory may be referred to as “Volatile memory” wherein the volatile memory only holds information while data is being used and/or processed. In one or more embodiments, volatile memory may lose information after a loss of power.

Computer system 800 may also include a storage device 824. Examples of a storage device (e.g., storage device 824) include, but are not limited to, a hard disk drive, a magnetic disk drive, an optical disc drive in combination with an optical medium, a solid-state memory device, and any combinations thereof. Storage device 824 may be connected to bus 812 by an appropriate interface (not shown). Example interfaces include, but are not limited to, SCSI, advanced technology attachment (ATA), serial ATA, universal serial bus (USB), IEEE 1394 (FIREWIRE), and any combinations thereof. In one example, storage device 824 (or one or more components thereof) may be removably interfaced with computer system 800 (e.g., via an external port connector (not shown)). Particularly, storage device 824 and an associated machine-readable medium 828 may provide nonvolatile and/or volatile storage of machine-readable instructions, data structures, program modules, and/or other data for computer system 800. In some embodiments, storage device 824 and/or devices “Secondary memory” also known as “storage,” “hard disk drive” and the like for the purposes of this disclosure is a long-term storage device in which an operating system and other information is stored; operating system and/or main program instructions may alternatively or additionally be stored in hard-coded memory ROM, or the like. In one or remote embodiments, information may be retrieved from secondary memory and copied to primary memory during use. In one or more embodiments, secondary memory may be referred to as non-volatile memory wherein information is preserved even during a loss of power. In some embodiments, data from secondary memory is transferred to primary memory before being accessed by a processor. In one or more embodiments, data is transferred from secondary to primary memory wherein circuitry 102 may access the information from primary memory. In one example, software 820 may reside, completely or partially, within machine-readable medium 828. In another example, software 820 may reside, completely or partially, within processor 804.

Computer system 800 may also include an input device 832. In one example, a user of computer system 800 may enter commands and/or other information into computer system 800 via input device 832. Examples of an input device 832 include, but are not limited to, an alpha-numeric input device (e.g., a keyboard), a pointing device, a joystick, a gamepad, an audio input device (e.g., a microphone, a voice response system, etc.), a cursor control device (e.g., a mouse), a touchpad, an optical scanner, a video capture device (e.g., a still camera, a video camera), a touchscreen, and any combinations thereof. Input device 832 may be interfaced to bus 812 via any of a variety of interfaces (not shown) including, but not limited to, a serial interface, a parallel interface, a game port, a USB interface, a FIREWIRE interface, a direct interface to bus 812, and any combinations thereof. Input device 832 may include a touch screen interface that may be a part of or separate from display 836, discussed further below. Input device 832 may be utilized as a user selection device for selecting one or more graphical representations in a graphical interface as described above.

A user may also input commands and/or other information to computer system 800 via storage device 824 (e.g., a removable disk drive, a flash drive, etc.) and/or network interface device 840. A network interface device, such as network interface device 840, may be utilized for connecting computer system 800 to one or more of a variety of networks, such as network 844, and one or more remote devices 848 connected thereto. Examples of a network interface device include, but are not limited to, a network interface card (e.g., a mobile network interface card, a LAN card), a modem, and any combination thereof. Examples of a network include, but are not limited to, a wide area network (e.g., the Internet, an enterprise network), a local area network (e.g., a network associated with an office, a building, a campus or other relatively small geographic space), a telephone network, a data network associated with a telephone/voice provider (e.g., a mobile communications provider data and/or voice network), a direct connection between two computing devices, and any combinations thereof. A network, such as network 844, may employ a wired and/or a wireless mode of communication. In general, any network topology may be used. Information (e.g., data, software 820, etc.) may be communicated to and/or from computer system 800 via network interface device 840.

Computer system 800 may further include a video display adapter 852 for communicating a displayable image to a display device, such as display 836. Examples of a display device include, but are not limited to, a liquid crystal display (LCD), a cathode ray tube (CRT), a plasma display, a light emitting diode (LED) display, and any combinations thereof. Display adapter 852 and display 836 may be utilized in combination with processor 804 to provide graphical representations of aspects of the present disclosure. In addition to a display device, computer system 800 may include one or more other peripheral output devices including, but not limited to, an audio speaker, a printer, and any combinations thereof. Such peripheral output devices may be connected to bus 812 via a peripheral interface 856. Examples of a peripheral interface include, but are not limited to, a serial port, a USB connection, a FIREWIRE connection, a parallel connection, and any combinations thereof.

Further referring to FIG. 8, a computing device may include any computing device as described in this disclosure, including without limitation a microcontroller, microprocessor, digital signal processor (DSP) and/or system on a chip (SoC) as described in this disclosure. A computing device may include, be included in, and/or communicate with a mobile device such as a mobile telephone or smartphone. A computing device may include a single device having components as described above operating independently, or may include two or more such devices and/or components thereof operating in concert, in parallel, sequentially or the like; two or more devices, processors, memory elements, and the like may be included together in a single computing device or in two or more computing devices. A computing device may interface or communicate with one or more additional devices as described below in further detail via a network interface device.

In some embodiments, and still referring to FIG. 8, a computing device may be a component of a combination of at least a computing device; at least a computing device may include, as a non-limiting example, a first computing device or cluster of computing devices in a first location and a second computing device or cluster of computing devices in a second location. At least a computing device may include one or more computing devices dedicated to data storage, security, distribution of traffic for load balancing, and the like. At least a computing device may distribute one or more computing tasks as described below across a plurality of computing devices of computing device, which may operate in parallel, in series, redundantly, or in any other manner used for distribution of tasks or memory between computing devices. At least a computing device may be implemented, as a non-limiting example, using a “shared nothing” architecture.

With continued reference to FIG. 8, one or more programs or software instructions may include a principal program and/or operating system; principal program and/or operating system may be a program that runs automatically upon startup of a computing device and manages computer hardware and software resources. Principal program and/or operating system may include “startup,” “loop,” and/or “main” programs on a microcontroller; such programs may initialize hardware resources and subsequently iterate through a series of instructions to make function calls, read in data at input ports, output data at output ports, and process interrupts caused by asynchronous data inputs or the like. Principal program and/or operating system may include, without limitation, an operating system, which may schedule program tasks to be implemented by one or more processors, act as an intermediary between one or more programs and inputs, outputs, hardware and/or memory. Examples of operating systems include without limitation Unix, Linux, Microsoft Windows, Android, Disc Operating System (DOS) and the like. Operating systems may include, without limitation, multi-computer operating systems that run across multiple computing devices, real-time operating systems, and hypervisors. A “hypervisor,” as used in this disclosure, is an operating system that runs a virtual machine and/or container, where virtual machines and/or containers create virtual interfaces for programs that mimic the behavior of hardware elements such as processors and/or memory; interactions with such virtual interfaces appear, to programs executed on virtual machines, to function as interactions with physical hardware, while in reality the hypervisor and/or programs such as containers (1) receive inputs from programs to the virtual resources and allocate such inputs to physical hardware that is not directly accessible to the programs, and (2) receive outputs from physical hardware and transmit such outputs to the programs in the form of apparent outputs from the virtual hardware. In some cases, one or more of computing system 800, processor 804, and memory 808 may be virtualized; that is, a virtual machine and/or container may interact directly with such computing system 800, processor 804, and/or memory 808, while managing communications therefrom and thereto via a virtual interface with programs. Computer virtualization may include dividing, or augmenting computing resources into a virtual machine, operating system, processor, and/or container. Virtualization of computer resources may be implemented through use of (1) multiple components, or portions thereof, working in concert, as if they were one unified (virtual) component; and/or (2) a portion of one or more components working as though it were a complete (virtual) component. For instance, where processor 804 comprises a plurality of processors and/or processor cores, virtualization may, in some cases, simulate or emulate a single (virtual) processor whose functions are allocated to one or more of the plurality of processors and/or processor cores. In this case, while processor 804 may be said to be virtualized, the processor 804, nevertheless, comprises actual hardware processor(s) or portion(s) thereof. Accordingly, in this disclosure, where a processor is said to perform instructions, such processor may comprise a virtualized processor, comprising a plurality or portion of hardware processors. Likewise, in this disclosure, where a memory is said to contain (i.e., store) instructions, such memory may comprise a virtualized memory, comprising a plurality or portion of memories. Technologies that enable such virtualization include (1) QEMU, www.qemu.org; (2) VMware by Broadcom Inc of Palo Alto, California; (3) VirtualBox by Oracle Corporation headquartered in Austin, Texas; and (4) kernel-based virtual machine (KVM) www.linux-kvm.org.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve methods, systems, and software according to the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A system for generating an action strategy, wherein the system comprises:
at least a processor; and
a memory communicatively connected to the processor, the memory containing instructions configuring the at least a processor to:
receive composition data from a user;
classify the composition data to one or more composition groups;
determine an action item as a function of the one or more composition groups; and
generate an action strategy as a function of the action item.

2. The system of claim 1, wherein the composition data comprises document data.

3. The system of claim 1, wherein the composition data is classified to the one or more composition groups using a group classifier, wherein the group classifier is configured to:
receive group training data, wherein the group training data comprises the composition data; and
classify the group training data to the one or more composition groups.

4. The system of claim 1, further configured to provide a composition course as a function of the one or more composition groups.

5. The system of claim 1, wherein determining the action item comprises receiving an item response from the user.

6. The system of claim 5, wherein the item response comprises a course response.

7. The system of claim 5, wherein determining the action item comprises determining an item status of the action item as a function of the item response using a status machine-learning model.

8. The system of claim 7, wherein the item status comprises a course status, wherein the course status comprises a completion status of the composition course.

9. The system of claim 7, wherein determining the action item further comprises:
generating, using an action machine-learning model, a first action item, wherein the action machine-learning model is configured to correlate action training data to the action item;
receiving, using the at least a processor, the course response from the user for the first action item;
determining, using the status machine-learning model, the completion status of the composition course; and
identifying, using the action machine-learning model, a second action item as a function of the completion status of the composition course.

10. The system of claim 1, wherein at least a processor is further configured to generate a report using a graph machine-learning model, wherein the report comprises a graphically represented item of the composition data and generating the report using the graph machine-learning model further comprises:
receiving a graph training data, wherein the graph training data comprises the composition data; and
creating the report as a function of the graph training data set, where in the report comprises the graphically represented item of the composition data.

11. A method for generating an action strategy, wherein the method comprises:
receiving, using at least a processor, composition data from a user;
classifying, using the at least a processor, the composition data to one or more composition groups;
determining, using the at least a processor, an action item as a function of the one or more composition groups; and
generating, using the at least a processor, an action strategy as a function of the action item.

12. The method of claim 11, wherein the composition data comprises document data.

13. The method of claim 11, wherein the composition data is classified to the one or more composition groups using a group classifier, wherein the group classifier is configured to:
receive group training data, wherein the group training data comprises the composition data; and
classify the group training data to the one or more composition groups.

14. The method of claim 11, further comprising providing, using the at least a processor, a composition course as a function of the one or more composition groups.

15. The method of claim 11, wherein determining the action item comprises receiving an item response from the user.

16. The method of claim 15, wherein the item response comprises a course response.

17. The method of claim 15, wherein determining the action item comprises determining an item status of the action item as a function of the item response using a status machine-learning model.

18. The method of claim 17, wherein the item status comprises a course status, wherein the course status comprises a completion status of the composition course.

19. The method of claim 17, wherein determining the action item further comprises:
generating, using an action machine-learning model, a first action item, wherein the action machine-learning model is configured to correlate action training data to the action item;
receiving, using the at least a processor, the course response from the user for the first action item;
determining, using the status machine-learning model, the completion status of the composition course; and
identifying, using the action machine-learning model, a second action item as a function of the completion status of the composition course.

20. The method of claim 11, further comprising:
generating, using the at least a processor, a report using a graph machine-learning model, wherein the report comprises a graphically represented item of the composition data and generating the report using the graph machine-learning model further comprises:
receiving a graph training data, wherein the graph training data comprises the composition data; and
creating the report as a function of the graph training data set, where in the report comprises the graphically represented item of the composition data.
